(19) United States
(12) Patent Application Publication
(10) Pub. No.: US 2023/0312138 A1
(43) Pub. Date: Oct. 5, 2023

(54) SYSTEM AND METHOD FOR RECHARGING AN ELECTRIC VEHICLE

(71) Applicant: BETA AIR, LLC, SOUTH BURLINGTON, VT (US)

(72) Inventor: Herman Wiegman, South Burlington, VT (US)

(73) Assignee: BETA AIR, LLC, SOUTH BURLINGTON, VT (US)

(21) Appl. No.: 18/206,444

(22) Filed: Jun. 6, 2023

Related U.S. Application Data
(63) Continuation-in-part of application No. 17/884,011, filed on Aug. 9, 2022.
Application No. 17/884,011 is a continuation-in-part of application No. 17/515,510, filed on Oct. 31, 2021, now Pat. No. 11,708,000.

(51) Int. Cl. B64F 1/36; B60L 53/16; B64D 13/06; B64D 43/00

(52) U.S. Cl. CPC B64F 1/362; B60L 53/16; B64D 13/06; B64D 43/00; B60L 2200/10; B60L 53/302

(57) ABSTRACT

A system for recharging an electric vehicle including a recharging component, wherein the recharging component is configured to supply power to an energy source of an electric vehicle, a sensor, wherein the sensor is configured to detect a plurality of data regarding the electric vehicle and generate an environment datum as a function of the plurality of data, a ventilation system, wherein the ventilation system is communicatively connected to the recharging component and a control pilot, wherein the control pilot is in electronic communication with the sensor, wherein the control pilot is configured to receive the environment datum from the sensor, generate a ventilation requirement datum as a function of the environment datum and command the ventilation system to perform a ventilation process as a function of the ventilation requirement datum.

### CROSS-REFERENCE TO RELATED APPLICATIONS

This application is a continuation-in-part of U.S. patent application Ser. No. 17/884,011 filed on Aug. 9, 2022, and entitled “SYSTEM AND METHOD FOR RECHARGING AN ELECTRIC VEHICLE,” which is a continuation-in-part of U.S. Nonprovisional application Ser. No. 17/515,510 filed on Oct. 31, 2021 and entitled “SYSTEM AND METHOD FOR RECHARGING AN ELECTRIC VEHICLE,” each of which are incorporated herein by reference in their entirety.

### FIELD OF THE INVENTION

The present invention generally relates to the field of systems and methods for recharging an electric vehicle. In particular, the present invention relates to ventilation systems of a recharging component.

### BACKGROUND

Electric vehicles require periodic recharging. Most recharging stations simply charge a power source of an electric vehicle without assuring a quality of recharging and environmental elements that may affect a power source of an electric vehicle. As such, modern recharging systems are basic and can be improved.

### SUMMARY OF THE DISCLOSURE

In an aspect, a system for providing ventilation to an electric vehicle. The system includes a recharging component, wherein the recharging component is configured to supply power to an energy source of an electric vehicle, a sensor, wherein the sensor is configured to detect a plurality of data regarding the electric vehicle and generate an environment datum as a function of the plurality of data, a ventilation system, wherein the ventilation system is communicatively connected to the recharging component and a control pilot, wherein the control pilot is in electronic communication with the sensor, wherein the control pilot is configured to receive the environment datum from the sensor, generate a ventilation requirement datum as a function of the environment datum and command the ventilation system to perform a ventilation process as a function of the ventilation requirement datum.

In another aspect, a method of providing ventilation to an electric vehicle is disclosed. A method includes providing a recharging component of an electric vehicle, wherein the recharging component is configured to supply power to an energy source of an electric vehicle, providing a ventilation system of the electric vehicle, wherein the ventilation system is communicatively connected to the recharging component, detecting, by a sensor, a plurality of data regarding the electric vehicle, generating, by the sensor, an environment datum as a function of the plurality of data, receiving, at a control pilot of the electric aircraft, the environment datum from the sensor, generating, using the control pilot, a ventilation requirement datum as a function of the environment datum and commanding, using the control pilot, the ventilation system to perform a ventilation process as a function of the ventilation requirement datum.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of a system for recharging an electric vehicle;

FIG. 2 is a diagram illustrating an electric charging station for an electric vehicle;

FIG. 3 is a block diagram of an exemplary electric charging station for an electric vehicle;

FIG. 4 is a block diagram of a sensor suite;

FIG. 5 is an exemplary embodiment of an electric aircraft;

FIG. 6 is an exemplary embodiment of a battery module;

FIG. 7 is an exemplary embodiment of a flight controller of an aircraft;

FIG. 8 is a block diagram of a machine learning system;

FIG. 9 is a flowchart for a method of controlling a ventilation process of electric vehicle;

FIG. 10 is a flowchart for another method of providing ventilation to an electric vehicle; and

FIG. 11 is a block diagram of an exemplary embodiment of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

Described herein a system for recharging an electric vehicle. The system includes a recharging component, wherein the recharging component is configured to supply power to an energy source of an electric vehicle, a sensor, wherein the sensor is coupled to the recharging component and configured to detect a plurality of data from the recharging component and generate an environment datum as a function of the plurality of data, a ventilation system, wherein the ventilation system is communicatively connected to the recharging component and a control pilot, wherein the control pilot is in electronic communication with the sensor, wherein the control pilot is configured to receive the environment datum from the sensor, generate a ventilation requirement datum as a function of the environment datum and command the ventilation system to perform a ventilation process as a function of the ventilation requirement datum.

Described herein is a method of providing ventilation to an electric aircraft during recharging of an energy source of the electric aircraft. A method includes providing a recharging component of an electric vehicle, wherein the recharging component is configured to supply power to an energy source of an electric vehicle, providing a ventilation system of the electric vehicle, wherein the ventilation system is communicatively connected to the recharging component, detecting, by a sensor, a plurality of data from the recharging component, generating, by the sensor, an environment datum as a function of the plurality of data, receiving, at a control pilot of the electric aircraft, the environment datum from the sensor, generating, using the control pilot, a ventilation requirement datum as a function of the environment datum and commanding, using the control pilot, the ventilation system to perform a ventilation process as a function of the ventilation requirement datum.

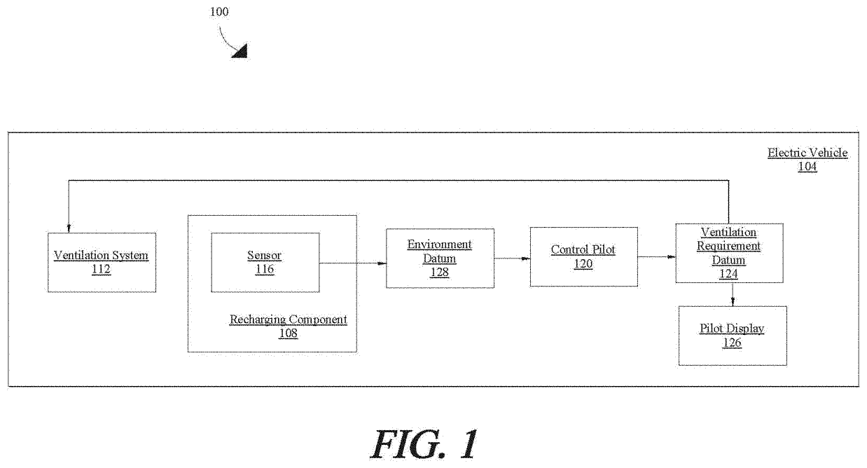

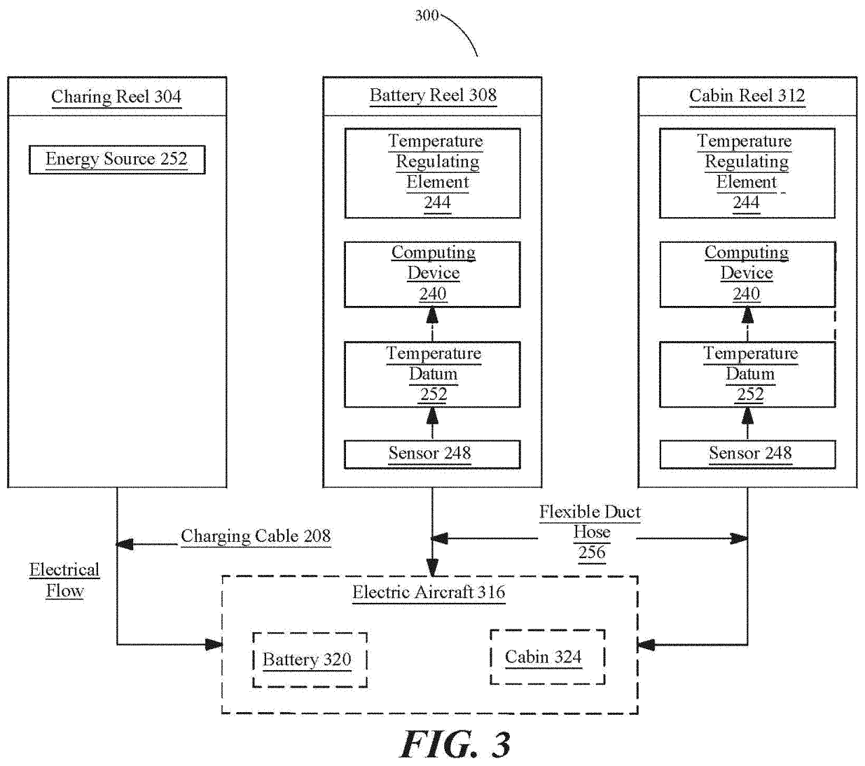

Referring now to FIG. 1, a system 100 for providing ventilation during a recharging of an electric vehicle is presented. System 100 may include electric vehicle 104. Electric vehicle 104 may include any vehicle partially or completely powered by electricity. In some embodiments, electric vehicle 104 may include an electric aircraft. An electric aircraft may include an electric vertical takeoff and landing vehicle, or eVTOL. In some embodiments, an electric aircraft may be as described in detail below with reference to FIG. 3.

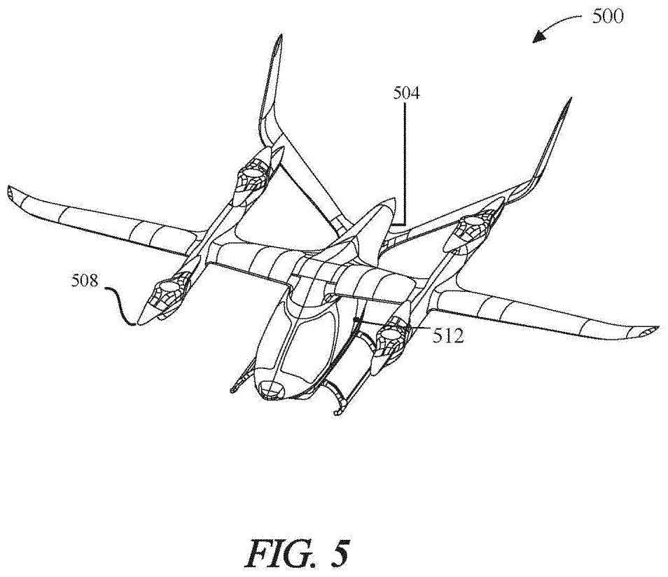

Still referring to FIG. 1, system 100 may include recharging component 108. A “recharging component” as used in this disclosure is any device and/or component of an electric aircraft capable of providing power to an energy source of electric vehicle 104. In other embodiments, recharging component 108 may include an electric aircraft port, such as electric aircraft port 512 (shown in FIG. 5). An electric aircraft port may include a mechanical connection that allows for a connector of a charger and/or charging station to connect to electric aircraft and transfer electrical power from the charger to the power source of the electric vehicle. In some embodiments, a charging station may include, but is not limited to, a constant voltage charger, a constant current charger, a taper current charger, a pulsed current charger, a negative pulse charger, an IUI charger, a trickle charger, a float charger, and/or other chargers. In some embodiments, recharging component 108 may include a charging connector. Recharging component 108 may be configured to receive power for electric vehicle 104. In some embodiments, recharging component 108 may be configured to deliver a voltage and/or current to the energy source of electric vehicle 104. In some embodiments, recharging component 108 may be configured to deliver 240V to energy source of electric vehicle 104. In some embodiments, recharging component 108 may be configured to deliver 50A to energy source of electric vehicle 104. In some embodiments, recharging component 108 may include power supply circuitry. Power supply circuitry may include a plurality of electrical components, such as, but not limited to, resistors, capacitors, inductors, transistors, transformers, integrated circuit chips, and the like.

Still referring to FIG. 1, electric vehicle 104 may include a ventilation system 112. In some embodiments, ventilation system 112 may be configured to lead a flow of air and/or airborne particles away from electric vehicle 104. In some embodiments, ventilation system 112 may be configured to lead a flow of air and/or airborne particles into electric vehicle 104. In some embodiments, ventilation system 112 may include a ventilation ducting system. A “ventilation ducting system” as used in this disclosure is a group of holes, passages, tubes, or other conduits for gases and particulates, configured to permit a flow of air, gases, and/or particulates away or towards an object. In some embodiments, a ventilation ducting system may be configured to direct a flow of heated air away from electric vehicle 104. In some embodiments, ventilation ducting system may be configured to direct a flow of air to electric vehicle 104. In a non-limiting example, a ventilation ducting system may be configured to direct a flow of cool air to electric vehicle 104. In some embodiments, recharging component 108 may be configured to direct a flow of air and/or airborne particles into electric aircraft 104 and/or cabin of electric aircraft 104. The cabin disclosed herein is further described below. In some embodiments, ventilation system 112 may include a plurality of exhaust devices, such as, but not limited to, vanes, blades, rotors, impellers, and the like. In some embodiments, an exhaust device of ventilation system 112 may be mechanically coupled to an energy source. An energy source may include, but is not limited to, electric motors, batteries, and the like. In some embodiments, ventilation system 112 may include a flow controlling device such as, but not limited to, actuators, valves, control circuits, and the like. Flow controlling devices may be configured to adjust an amount of air flowing through ventilation system 112. Flow controlling devices may work together, separately, or a combination of the two. In a non-limiting example, a flow controlling device may include a valve. In some embodiments, valve may be configured to open a flow pathway for air away from electric vehicle 104. In some embodiments, valve may be configured to open a flow pathway for air into electric vehicle 104. Continuing this example, the valve may open or close the flow pathway for air around electric vehicle 104 based on instructions from ventilation system 112. In some embodiments, ventilation system 112 may adjust power to one or more flow controlling devices and/or exhaust devices. In a non-limiting example, ventilation system 112 may include an actuator. Ventilation system 112 may control a power delivered to the actuator that may correspond to a movement of a blower, impeller, and the like.

Still referring to FIG. 1, recharging component 108 may include sensor 116. Sensor 116 may be attached to recharging component 108. “Attachment” as used in this disclosure is a physical connection between two or more components. In some embodiments, sensor 116 may include a plurality of sensing devices, such as, but not limited to, temperature sensors, humidity sensors, accelerometers, electrochemical sensors, gyroscopes, magnetometers, inertial measurement unit (IMU), pressure sensor, proximity sensor, displacement sensor, force sensor, vibration sensor, air detectors, hydrogen gas detectors, and the like. Sensor 116 may be configured to detect a plurality of data. A plurality of data may be detected from recharging component 108, and/or any other component of electric vehicle 104, or charger. In some embodiments, a plurality of data may be detected from an environment of recharging component 108. In some embodiments, a plurality of data may be detected from a cabin of electric vehicle 104. A plurality of data may include, but is not limited to, airborne particles, weather, temperature, air quality, and the like. In some embodiments, airborne particles may include hydrogen gas and/or any gas that may degrade a battery of electric vehicle 104. Sensor 116 may detect a plurality of data about an energy source of electric vehicle 104. A plurality of data about an energy source may include, but is not limited to, battery quality, battery life cycle, remaining battery capacity, and the like. In some embodiments, sensor 116 may be configured to measure data including degradation parameters. A “degradation parameter” as used in this disclosure is any factor that may damage an energy source of an electric vehicle. In some embodiments, recharging component 108 may receive data from an external computing device. An external computing device may include, but is not limited to, a smartphone, tablet, desktop, laptop, and/or electric vehicle 104. In some embodiments, recharging component 108 may receive data about an electric vehicle 104 such as, but not limited to, a flight plan, payload, fleet requirement, and the like. In some embodiments, sensor 116 may be configured to generate environment datum 128. Environment datum 128 may include, but is not limited to, air quality, temperature, weather, humidity, pressure, voltage, current, resistance, battery quality, battery life cycle, battery capacity, and the like. Sensor 116 may be configured to transmit environment datum 128 to a control pilot 120 of electric vehicle 104, as discussed further below. In some embodiments, environment datum 128 may concern the environment of an aircraft cabin. As a non-limiting example, environment datum 128 may include

Still referring to FIG. 1, in some embodiments, electric vehicle 104 may include control pilot 120. For instance, and without limitation, control pilot 120 may be communicatively connected to recharging component 108, such as a port of electric vehicle 104, and/or an energy source of electric vehicle 104. In various embodiments, control pilot 120 may be attached to electric aircraft port. In other embodiments, control pilot 120 may be remote to electric aircraft port. As used herein, “communicatively connected” is a process whereby one device, component, or circuit is able to receive data from and/or transmit data to another device, component, or circuit. In an embodiment, communicative connecting includes electrically connecting at least an output of one device, component, or circuit to at least an input of another device, component, or circuit. Control pilot 120 may include any computing device as described throughout this disclosure. For example, and without limitation, control pilot 120 may include a flight controller, microprocessor, processor, control circuit, computing device, and the like. Control pilot 120 may be configured to receive environment datum 128 from sensor 116. In some embodiments, control pilot 120 may be configured to generate ventilation requirement datum 124. Ventilation requirement datum 124 may be generated as a function of environment datum 128. In some embodiments, ventilation requirement datum 124 may include a plurality of data, such as, but not limited to, air quality, battery quality, battery temperature, battery degradation, and the like. Ventilation requirement datum 124 may be generated based on a plurality of data of electric vehicle 104, such as, but not limited to, flight plans, payload, fleet requirements, temperature threshold, gas concentration threshold, particulate concentration threshold, and the like. In some embodiments, control pilot 120 may be configured to operate recharging component 108. Control pilot 120 may operate recharging component 108 and/or ventilation system 112 as a function of ventilation requirement datum 124. In a non-limiting example, ventilation requirement datum 124 may include data showing that air quality around recharging component 108 may be worse than normal. Control pilot 120 may communicate activate ventilation system 112 to improved air quality. Control pilot 120 may communicate to recharging component 108 to activate ventilation system 112. In some cases, air in a cabin of aircraft may be too hot. In response, control pilot 120 may activate ventilation system 112 in order to provide ventilation to cabin of aircraft. In another non-limiting example, ventilation requirement datum 124 may include data showing that there may be an increase of hydrogen gas around recharging component 108. Control pilot 120 may communicate to electric vehicle 104 to expel the hydrogen gas through ventilation system 112. Control pilot 120 may communicate to recharging component 108 to expel the hydrogen gas through ventilation system 112. Control pilot 120 may operate a charging function of recharging component 108. In some embodiments, control pilot 120 may operate ventilation system 112 of electric vehicle 104. Control pilot 120 may utilize a machine-learning model to predict ventilation requirement datum 124 as a function of environment data 128. In some embodiments, control pilot 120 may utilize a machine-learning model. A machine-learning model may be trained using training data correlating parameter combinations to states requiring ventilation. States requiring ventilation may include, but are not limited to, thermal runaway conditions, dangerous gas build up, and the like. Control pilot 120 may utilize a machine-learning model to detect early warning signs of hazardous conditions or recharging component 108.

Still referring to FIG. 1, in some embodiments, electric vehicle 104 may include pilot display 126. Pilot display 126 may include any display. Pilot display 126 may include an output device. An “output device”, for the purposes of this disclosure, refers to a visual apparatus that is comprised of compact flat panel designs, liquid crystal display, organic light-emitting diode, or combination thereof to present visual information superimposed on spaces. Pilot display 126 may include a graphical user interface (GUI), multi-functional display (MFD), primary flight display (PFD), gages, dials, screens, touch screens, speakers, haptic feedback device, live feed, window, combination thereof, or another display type. In a nonlimiting embodiment, pilot display 126 may include a mobile computing device like a smartphone, tablet, computer, laptop, client device, server, a combination thereof, or another undisclosed display alone or in combination. Pilot display 126 may be disposed in at least a portion of a cockpit of an electric aircraft. Pilot display 126 may be a heads-up display (HUD) disposed in goggles, glasses, eye screen, or other headwear a pilot or user may be wearing. Pilot display 126 may include augmented reality, virtual reality, or combination thereof. Pilot display 126 may include monitor display that may display information in pictorial form. Monitor display may include visual display, computer, and the like. For example, monitors display may be built using liquid crystal display technology that displays to the pilot information from a computer's user interface. Pilot display 126 may be configured to display ventilation requirement datum 124. In some embodiments, pilot display 126 may display, but is not limited to, air quality, battery temperature, battery degradation, battery charge, recharging component temperature, voltage, current, resistance, power received from recharging component, and the like.

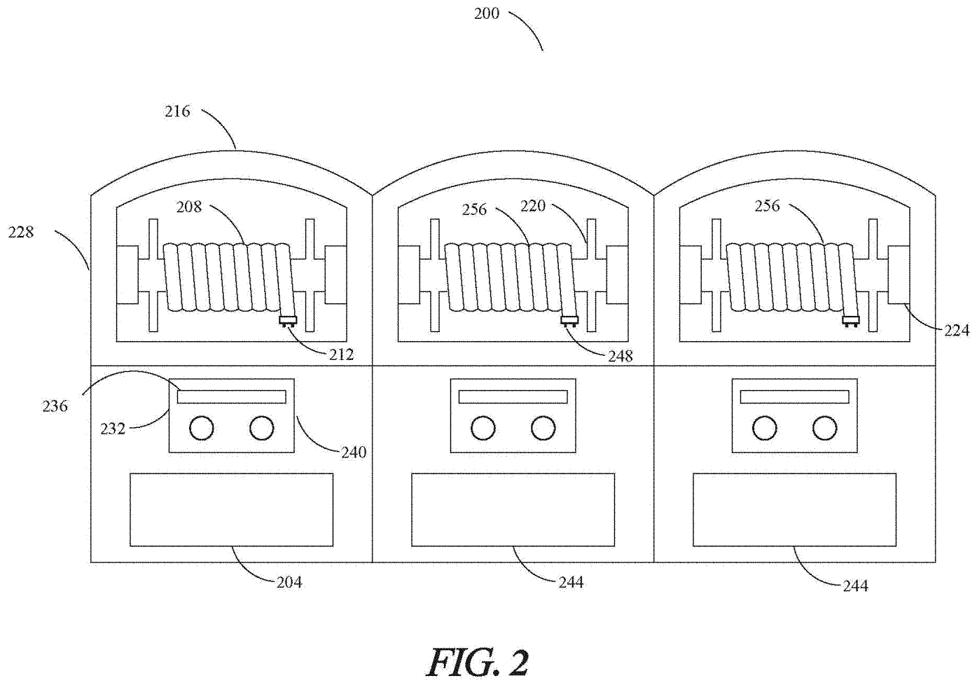

Referring now to FIG. 2, an embodiment of an electric aircraft charging station 200 is shown. Charging station 200 includes an energy source 204. An “energy source,” for the purposes of this disclosure, is a source of electrical power. In some embodiments, energy source 204 may be an energy storage device, such as, for example, a battery or a plurality of batteries. A battery may include, without limitation, a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. Additionally, energy source 204 need not be made up of only a single electrochemical cell, it can consist of several electrochemical cells wired in series or in parallel. In other embodiments, energy source 204 may be a connection to the power grid. For example, in some non-limiting embodiments, energy source 204 may include a connection to a grid power component. Grid power component may be connected to an external electrical power grid. In some other embodiments, the external power grid may be used to charge batteries, for example, when energy source 204 includes batteries. In some embodiments, grid power component may be configured to slowly charge one or more batteries in order to reduce strain on nearby electrical power grids. In one embodiment, grid power component may have an AC grid current of at least 450 amps. In some embodiments, grid power component may have an AC grid current of more or less than 450 amps. In one embodiment, grid power component may have an AC voltage connection of 480 Vac. In other embodiments, grid power component may have an AC voltage connection of above or below 480 Vac. Some components of charging station 200 may be consistent with the charger disclosed in U.S. application Ser. No. 17/477,987 filed on Sep. 17, 2021, titled “Systems and Methods for Adaptive Electric aircraft,” the entirety of which is hereby incorporated by reference. Additionally, some components of charging station 200 may be consistent with the charger disclosed in U.S. application Ser. No. 17/515,448 filed on Oct. 31, 2021, titled “Systems and Methods for an Immediate Shutdown of an Electric aircraft Charger,” the entirety of which is hereby incorporated by reference.

With continued reference to FIG. 2, charging station 200 may include a charging cable 208. A “charging cable,” for the purposes of this disclosure is a conductor or conductors adapted to carry power for the purpose of charging an electronic device. Charging cable 208 is configured to carry electricity. Charging cable 208 is electrically connected to the energy source 204. “Electrically connected,” for the purposes of this disclosure, means a connection such that electricity can be transferred over the connection. In some embodiments, charging cable 208 may carry AC and/or DC power to a charging connector 212. The charging cable may include a coating, wherein the coating surrounds the conductor or conductors of charging cable 208. One of ordinary skill in the art, after having reviewed the entirety of this disclosure, would appreciate that a variety of coatings are suitable for use in charging cable 208. As a non-limiting example, the coating of charging cable 208 may comprise rubber. As another non-limiting example, the coating of charging cable 208 may comprise nylon. Charging cable 208 may be a variety of lengths depending on the length required by the specific implementation. As a non-limiting example, charging cable 208 may be 10 feet. As another non-limiting example, charging cable 208 may be 25 feet. As yet another non-limiting example, charging cable 208 may be 50 feet.

With continued reference to FIG. 2, charging station 200 may include a charging connector 212. Charging cable 208 may be electrically connected to charging connector 212. Charging connector 212 may be disposed at one end of charging cable 208. Charging connector 212 may be configured to couple with a corresponding charging port on an electric aircraft. For the purposes of this disclosure, a “charging connector” is a device adapted to electrically connect a device to be charged with an energy source. For the purposes of this disclosure, a “charging port” is a section on a device to be charged, arranged to receive a charging connector.

With continued reference to FIG. 2, charging connector 212 may include a variety of pins adapted to mate with a charging port disposed on an electric aircraft. The variety of pins included on charging connector 212 may include, as non-limiting examples, a set of pins chosen from an alternating current (AC) pin, a direct current (DC) pin, a ground pin, a communication pin, a sensor pin, a proximity pin, and the like. In some embodiments, charging connector 212 may include more than one of one of the types of pins mentioned above.

With continued reference to FIG. 2, for the purposes of this disclosure, a “pin” may be any type of electrical connector. An electrical connector is a device used to join electrical conductors to create a circuit. As a non-limiting example, in some embodiments, any pin of charging connector 212 may be the male component of a pin and socket connector. In other embodiments, any pin of charging connector 212 may be the female component of a pin and socket connector. As a further example of an embodiment, a pin may have a keying component. A keying component is a part of an electrical connector that prevents the electrical connector components from mating in an incorrect orientation. As a non-limiting example, this can be accomplished by making the male and female components of an electrical connector asymmetrical. Additionally, in some embodiments, a pin, or multiple pins, of charging connector 212 may include a locking mechanism. For instance, as a non-limiting example, any pin of charging connector 212 may include a locking mechanism to lock the pins in place. The pin or pins of charging connector 212 may each be any type of the various types of electrical connectors disclosed above, or they could all be the same type of electrical connector. One of ordinary skill in the art, after reviewing the entirety of this disclosure, would understand that a wide variety of electrical connectors may be suitable for this application.

With continued reference to FIG. 2, in some embodiments, charging connector 212 may include a DC pin. DC pin supplies DC power. “DC power,” for the purposes of this disclosure, refers to a one-directional flow of charge. For example, in some embodiments, DC pin may supply power with a constant current and voltage. As another example, in other embodiments, DC pin may supply power with varying current and voltage, or varying currant constant voltage, or constant currant varying voltage. In another embodiment, when charging connector is charging certain types of batteries, DC pin may support a varied charge pattern. This involves varying the voltage or currant supplied during the charging process in order to reduce or minimize battery degradation. Examples of DC power flow include half-wave rectified voltage, full-wave rectified voltage, voltage supplied from a battery or other DC switching power source, a DC converter such as a buck or boost converter, voltage supplied from a DC dynamo or other generator, voltage from photovoltaic panels, voltage output by fuel cells, or the like.

With continued reference to FIG. 2, in some embodiments, charging connector may include an AC pin. An AC pin supplies AC power. For the purposes of this disclosure, “AC power” refers to electrical power provided with a bi-directional flow of charge, where the flow of charge is periodically reversed. AC pin may supply AC power at a variety of frequencies. For example, in a non-limiting embodiment, AC pin may supply AC power with a frequency of 50 Hz. In another non-limiting embodiment, AC pin may supply AC power with a frequency of 60 Hz. One of ordinary skill in the art, upon reviewing the entirety of this disclosure, would realize that AC pin may supply a wide variety of frequencies. AC power produces a waveform when it is plotted out on a current vs. time or voltage vs. time graph. In some embodiments, the waveform of the AC power supplied by AC pin may be a sine wave. In other embodiments, the waveform of the AC power supplied by AC pin may be a square wave. In some embodiments, the waveform of the AC power supplied by AC pin may be a triangle wave. In yet other embodiments, the waveform of the AC power supplied by AC pin may be a sawtooth wave. The AC power supplied by AC pin may, in general have any waveform, so long as the wave form produces a bi-directional flow of charge. AC power may be provided without limitation, from alternating current generators, “mains” power provided over an AC power network from power plants, AC power output by AC voltage converters including transformer-based converters, and/or AC power output by inverters that convert DC power, as described above, into AC power. For the purposes of this disclosure, “supply,” “supplies,” “supplying,” and the like, include both currently supplying and capable of supplying. For example, a live pin that “supplies” DC power need not be currently supplying DC power, it can also be capable of supplying DC power.

With continued reference to FIG. 2, in some embodiments, charging connector 212 may include a ground pin. A ground pin is an electronic connector that is connected to ground. For the purpose of this disclosure, “ground” is the reference point from which all voltages for a circuit are measured. “Ground” can include both a connection the earth, or a chassis ground, where all of the metallic parts in a device are electrically connected together. In some embodiments, “ground” can be a floating ground. Ground may alternatively or additionally refer to a “common” channel or “return” channel in some electronic systems. For instance, a chassis ground may be a floating ground when the potential is not equal to earth ground. In some embodiments, a negative pole in a DC circuit may be grounded. A “grounded connection,” for the purposes of this disclosure, is an electrical connection to “ground.” A circuit may be grounded in order to increase safety in the event that a fault develops, to absorb and reduce static charge, and the like. Speaking generally, a grounded connection allows electricity to pass through the grounded connection to ground instead of through, for example, a human that has come into contact with the circuit. Additionally, grounding a circuit helps to stabilize voltages within the circuit.

With continued reference to FIG. 2, in some embodiments, charging connector 212 may include a communication pin. A communication pin is an electric connector configured to carry electric signals between components of charging station 200 and components of an electric aircraft. As a non-limiting example, communication pin may carry signals from a controller in a charging system (e.g. controller 304) to a controller onboard an electric aircraft such as a flight controller or battery management controller. A person of ordinary skill in the art would recognize, after having reviewed the entirety of this disclosure, that communication pin could be used to carry a variety of signals between components.

With continued reference to FIG. 2, charging connector 212 may include a variety of additional pins. As a non-limiting example, charging connector 212 may include a proximity detection pin. Proximity detection pin has no current flowing through it when charging connector 212 is not connected to a port. Once charging connector 212 is connected to a port, then proximity detection pin will have current flowing through it, allowing for the controller to detect, using this current flow, that the charging connector 212 is connected to a port.

With continued reference to FIG. 2, charging station 200 may include multiple connectors. “Connectors” for the purposes of this disclosure are components that facilitate the transfer the of electrical power and/or thermal mediums between a source and an electric aircraft. Connector may be consistent with charging connector 212 described herein. Connector may be configured to couple with at least an electric vehicle port. In some cases, connector may be configured to couple with a receiving portion of an electric vehicle capable of receiving a thermal medium and/or electricity. Connector may include a charging connector, and/or a fluidic connector. A fluidic connector may facilitate the transfer of a thermal medium, such as coolant described herein, between a coolant source and an electric aircraft. In some cases, connector may include more than one fluidic connector such as a first fluidic connector and a second fluidic connector. A fluidic connector may include a temperature regulating element as described in this disclosure. In some cases, charging station may contain multiple fluidic connectors wherein each fluidic connector may contain a temperature regulating element. In some cases, temperature regulating element may be mechanically coupled to fluidic connector to facilitate the transfer of a thermal medium, such as coolant, within temperature regulating element and an electric vehicle. In some cases, a first fluidic connector may be mechanically coupled to a battery temperature regulating element, wherein the battery temperature regulating element is configured to provide a thermal medium to a battery of an electric aircraft. In some cases, battery temperature regulating element may be thermally connected to at least a battery of the electric vehicle through at least an electric vehicle port. In some cases, fluidic connector may facilitate the transfer of a thermal medium through the electric aircraft port. In some cases, battery temperature regulating element may contain a coolant flow path. Battery temperature regulating element may be consistent with temperature regulating element described herein. In some cases, battery temperature regulating element may modify a battery temperature of a battery or electric aircraft as a function of coolant flow. In some cases, coolant flow may control the temperature of a battery wherein the rate of a coolant may facilitate heat transfer between coolant and battery. In some cases, fluidic connector may include a cabin temperature regulating element, wherein the cabin temperature regulating element is configured to regulate the temperature within a cabin. In some cases, cabin temperature regulating element include battery temperature regulating element. In some cases, the regulating elements described herein are separate and distinct. In some cases, a second fluidic connector may also be mechanically coupled to cabin temperature regulating element wherein second fluidic connector may facilitate the transfer of a thermal medium within cabin temperature regulating element and an electric aircraft. In some cases, connector and/or fluidic connector may be consistent with flexible duct hose. In some cases, connector and/or fluidic connector may be consistent with a cable reel module as described herein.

With continued reference to FIG. 2, charging station 200 may include a cable reel module 216. The cable reel module 216 including a reel 220. For the purposes of this disclosure, a “cable reel module” is the portion of a charging system containing a reel, that houses a charging cable or a temperature regulating element when the charging cable is stowed. For the purposes of this disclosure, a “reel” is a rotary device around which an object may be wrapped. Reel 220 is rotatably mounted to cable reel module 216. For the purposes of this disclosure, “rotatably mounted” means mounted such that the mounted object may rotate with respect to the object that the mounted object is mounted on. Additionally, when the charging cable 208 is in a stowed configuration, the charging cable is wound around reel 220. As a non-limiting example, charging cable 208 is in the stowed configuration in FIG. 2. In the stowed configuration, charging cable 208 need not be completely wound around reel 220. As a non-limiting example, a portion of charging cable 208 may hang free from reel 220 even when charging cable 208 is in the stowed configuration. In some embodiments, a plurality of temperature regulating elements 244 may be located within a cable reel module 216. In embodiments, charging cable 208 may be replaced by a flexible duct hose 256 on the reel. The disclosure of the cable reel module 216 may be consistent with the disclosures of the cable reel module utilized to in U.S. Nonprovisional application Ser. No. 17/736,530 (Attorney Docket No. 1024-422USU1), filed on May 4, 2022, and entitled “SYSTEM FOR AN ELECTRIC AIRCRAFT CHARGING WITH A CABLE REEL”, the entirety of which is incorporated herein by reference.

With continued reference to FIG. 2, cable reel module 216 includes a rotation mechanism 224. A “rotation mechanism,” for the purposes of this disclosure is a mechanism that is configured to cause another object to undergo rotary motion. As a non-limiting example, rotation mechanism may include a rotary actuator. As a non-limiting example, rotation mechanism 224 may include an electric motor. As another non-limiting example, rotation mechanism 224 may include a servomotor. As yet another non-limiting example, rotation mechanism 224 may include a stepper motor. In some embodiments, rotation mechanism 224 may include a compliant element. For the purposes of this disclosure, a “compliant element” is an element that creates force through elastic deformation. As a non-limiting example, rotation mechanism 224 may include a torsional spring, wherein the torsional spring may elastically deform when reel 220 is rotated in, for example, the forward direction; this would cause the torsional spring to exert torque on reel 220, causing reel 220 to rotate in a reverse direction when it has been released. Rotation mechanism 224 is configured to rotate reel 220 in a forward direction and a reverse direction. Forward direction and reverse direction are opposite directions of rotation. As a non-limiting example, the forward direction may be clockwise, whereas the reverse direction may be counterclockwise, or vice versa. As a non-limiting example, rotating in the forward direction may cause charging cable 208 to extend, whereas rotating in the reverse direction may cause charging cable 208 to stow, or vice versa. In some embodiments, rotation mechanism 224 may continually rotate reel 220 when rotation mechanism 224 is enabled. In some embodiments, rotation mechanism 224 may be configured to rotate reel 220 by a specific number of degrees. In some embodiments, rotation mechanism 224 may be configured to output a specific torque to reel 220. As a non-limiting example, this may be the case, wherein rotation mechanism 224 is a torque motor. Rotation mechanism 224 may be electrically connected to energy source 204.

With continued reference to FIG. 2, a controller may be communicatively connected to rotation mechanism 224. Rotation mechanism 224 may be configured to rotate the reel in a forward direction and a reverse direction as a function of receiving a signal from controller. Controller may be configured to send an extension signal to rotation mechanism 224. The extension signal may cause rotation mechanism 224 rotate reel 220 in a forward direction. Controller 304 may also be configured to send a retraction signal to rotation mechanism 224. The retraction signal causes rotation mechanism 224 to rotate reel 220 in a reverse direction. Forward direction and reverse direction may be consistent with any forward direction and reverse direction, respectively, disclosed as part of this disclosure. In some embodiments, controller may be further configured to send a locking signal to a locking mechanism, wherein the locking signal causes the locking mechanism to enter its engaged state. In some embodiments, controller may be further configured to send an unlocking signal to locking mechanism. A “controller” for the purposes of this disclosure is any computing device that may be capable of sending and/or receiving a signal. Controller may be consistent with any computing device described herein.

With continued reference to FIG. 2, cable reel module 216 may include an outer case 228. Outer case 228 may enclose reel 220 and rotation mechanism 224. In some embodiments, outer case 228 may enclose charging cable 208 and possibly charging connector 212 when the charging cable 208 is in its stowed configuration.

With continued reference to FIG. 2, charging station 200 may include a control panel 232. For the purposes of this disclosure, a “control panel” is a panel containing a set of controls for a device. Control panel 232 may include a display 236. For the purposes of this disclosure, a “display” is an electronic device for the visual presentation of information. Display 236 may be any type of screen. As non-limiting examples, display 236 may be an LED screen, an LCD screen, an OLED screen, a CRT screen, a DLPT screen, a plasma screen, a cold cathode display, a heated cathode display, a nixie tube display, and the like. Display 236 may be configured to display any relevant information. A person of ordinary skill in the art would appreciate, after having reviewed the entirety of this disclosure, that a variety of information could be displayed on display 236. In some embodiments, display 236 may display metrics associated with the charging of an electric aircraft. As a non-limiting example, this may include energy transferred. As another non-limiting example, this may include charge time remaining. As another non-limiting example, this may include charge time elapsed.

Still referring now to FIG. 2, an exemplary embodiment of a charging station 200 is illustrated. System includes a computing device 240. computing device 240 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. computing device 240 may include a single computing device operating independently, or may include two or more computing device operating in concert, in parallel, sequentially or the like; two or more computing devices may be included together in a single computing device or in two or more computing devices. computing device 240 may interface or communicate with one or more additional devices as described below in further detail via a network interface device. Network interface device may be utilized for connecting computing device 240 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. computing device 240 may include but is not limited to, for example, a computing device or cluster of computing devices in a first location and a second computing device or cluster of computing devices in a second location. computing device 240 may include one or more computing devices dedicated to data storage, security, distribution of traffic for load balancing, and the like. computing device 240 may distribute one or more computing tasks as described below across a plurality of computing devices of computing device, which may operate in parallel, in series, redundantly, or in any other manner used for distribution of tasks or memory between computing devices. computing device 240 may be implemented using a “shared nothing” architecture in which data is cached at the worker, in an embodiment, this may enable scalability of charging station 200 and/or computing device.

With continued reference to FIG. 2, computing device 240 may be designed and/or configured to perform any method, method step, or sequence of method steps in any embodiment described in this disclosure, in any order and with any degree of repetition. For instance, computing device 240 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 240 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 2, computing device 240 may be configured to determine the target temperature of the battery. As used in this disclosure, “target temperature” is an ideal or otherwise preset temperature of a battery or cabin; target temperature may be calculated based on a culmination one or more factors such as weather, flight mode, altitude, external temperature, and the like. In some embodiments, computing device 240 may be configured to generate target temperature as a function of the flight plan. As used in the current disclosure, a “flight plan” is a plan to get the aircraft from its departure point to it arrival point in the most efficient manner with respect to flight duration, payload size, aircraft identity, and the like. In a non-limiting, example the target temperature of the battery may adjust based on the duration of the flight or the payload size. Target temperature may allow for a larger or smaller range of temperature for flights that are more strenuous on the battery according to the flight plan.

With continued reference to FIG. 2, computing device 240 may be configured to determine the target temperature of the battery or cabin as a function of battery considerations. Battery considerations may include status of charge of the battery, the number of battery modules, and overall battery health. In embodiments, a computing device may calculate target temperature as a function of a location of a charging station as it relates to of a current charge of the battery. In other embodiments, a target temperature of a battery may be calculated based on health of the battery adjusting for suboptimal battery health. Target temperature may also be calculated based on a number of battery modules adjusting for heat each battery produces.

With continued reference to FIG. 2, temperature regulating elements 244 may be configured to regulate the temperature of the battery cells or cabin. As used in the current disclosure, “regulating the temperature” means managing increase or decrease of the temperature of the battery. Temperature regulation also includes getting to and then maintaining a target temperature. Sensor feedback may be used in this process, whereas the sensor is used as a thermostat.

With continued reference to FIG. 2, computing device 240 may be configured to determine the target temperature of the battery as a function of the weather. As used in this disclosure, “weather” is defined as the state of the atmosphere at a place and time as regards temperature, coolness, heat, dryness, sunshine, wind, snow, hail, rain, and the like. Weather may also include but is not limited to ambient temperature, average temperature at different altitudes, wind speed, humidity, etc. As used in the current disclosure, “weather datum′ is the datum that is used to calculate the weather at a given time such as wind speed, humidity, temperature at a given altitude, temperature on the ground, and the like. In some embodiments, weather may be calculated outside the system then communicated to computing device 240. In some embodiments, weather datum bay be transmitted to computing device by a remote device. In other embodiments, computing device 240 derives the weather as a function of the weather datum. Weather datum may be detected through the use of one or more sensors communicatively connected to a computing device. The various weather events may cause the battery temperature to heat or cool accordingly. Changes in a target temperature may reflect the changes in the weather in order to maintain the ideal temperature of the battery.

With continued reference to FIG. 2, computing device 240 may be configured to calculate the target temperature of the battery as a function of the weather using an equation. As used in the current disclosure, an “equation” is a mathematical formula that will take into account at least the current temperature of the battery and the weather to output the target temperature of the battery. In some embodiments.

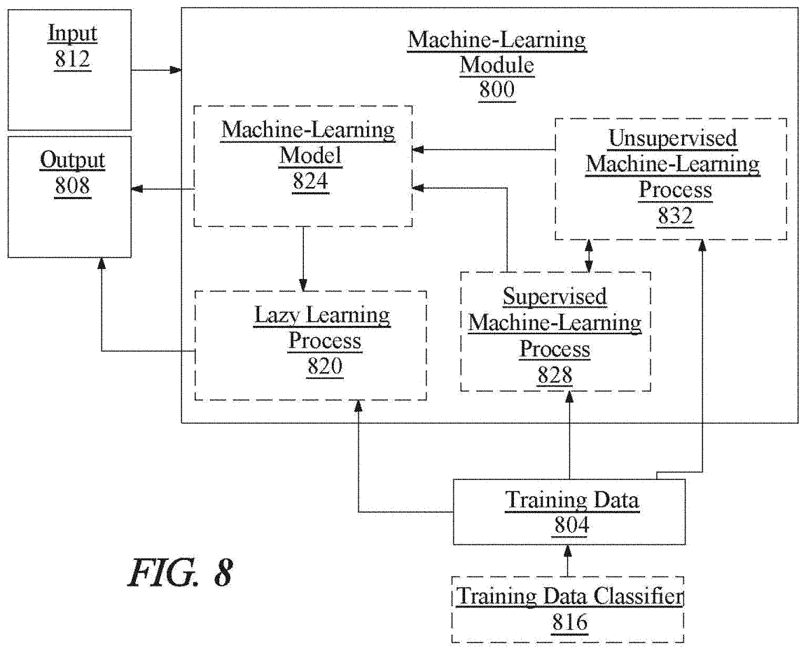

With continued reference to FIG. 2, computing device 240 may be configured to calculate the target temperature of the battery as a function of the weather using a machine learning process. Machine-learning module may perform determinations, classification, and/or analysis steps, methods, processes, or the like as described in this disclosure using machine learning processes. In some embodiments, machine learning process may produce a preflight battery temperature given data provided as inputs. The machine learning process disclosed herein is further described with respect to FIG. 8. In some embodiments, the inputs into the machine learning process are weather datum and the output of the process the target temperature of the battery. In a non-limiting example, training data that may be correlated include destinations, weather datum, flight plan data, weather, and the like. In some embodiments, training data may include recorded previous flights where batteries acted within an optimal range, did not require modifications to the flight plan due to temperature issues, and did not exceed or drop below a desired temperature range. In some embodiments, training data may be generated via electronic communication between a computing device and plurality of sensors. In other embodiments, training data may be communicated to a machine learning model from a remote device. Once the flight plan machine learning process receives training data, it may be implemented in any manner suitable for generation of receipt, implementation, or generation of machine learning.

With continued reference to FIG. 2, computing device 240 may be configured to calculate the target temperature of the battery as a function of the weather using a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In some embodiments, weather datum may be used a query to retrieve the target temperature of the battery.

With continued reference to FIG. 2, a computing device 240 may be configured to command the temperature regulating elements 244 to maintain the temperature of the plurality of battery cells. In embodiments, Computing device 240 will be communicatively connected with temperature regulating elements. Computing device 240 may command the temperature regulating elements to heat or cool the battery as needed as a function of the target temperature with the goal of maintaining the target temperature of the battery.

With continued reference to FIG. 2, Charging Station 200 may include a plurality temperature regulating element 244. As used in the current disclosure a “temperature regulating element” is any device configured to maintain the target temperature of the battery or cabin through the use of heating and/or cooling elements. In a non-limiting embodiment, a temperature regulating element 244 may be one or any combination of include heat exchangers, heaters, coolers, air conditioners, sheet heaters, and the like. In other embodiments, materials with high or low thermal conductivity, insulators, and convective fluid flows may be used to regulate the temperature of the battery. In a nonlimiting example, temperature regulating elements 244 may be located in gaps between the battery cells. Temperature may be applied to the aircraft using a flexible duct hose 256. As used in the current disclosure, a “flexible duct hose” is a flexible cylindrical hose that that is tailored to allow hot or cold air to pass through it to facilitate heating or cooling form temperature regulating elements 244. Flexible duct hose 256 may also be configured to allow coolant, materials with high or low thermal conductivity, insulators, and convective fluid flows may be used to regulate the temperature of the battery to flow through them. In some cases, flexible duct hose may include a collapsible duct hose. A “collapsible duct hose” for the purposes of this disclosure is a hose that may expand and contract. Collapsible duct hose may expand in use wherein a fluid or a medium traveling within collapsible duct hose may cause the hose to expand. In some cases, the absence of a thermal medium within collapsible duct hose may cause collapsible duct hose to retract. In some cases, collapsible duct hose may allow for easy storage. In some cases, collapsible duct hose may be consistent with a fire hose.

With continued reference to FIG. 2, temperature regulating element 244 may include a heating element. As used in the current disclosure, a “heating element” is a device used to raise the temperature of the battery or cabin. In a non-limiting example, heating elements may include sheet heaters, heat exchangers, heaters, and the like. In an embodiment, a heating element may blow heated air into the cabin or the battery to maintain the target temperature. As used in the current disclosure, a “sheet heaters” may include any heating element that is thin and flexible such as to be wrapped around a battery cell, inserted between two battery cells, or the like. Examples of sheet heaters include but are not limited to thick film heaters, sheets of resistive heaters, a heating pad, heating film. heating blanket, and the like. In embodiments, sheet heaters may be wrapped around a battery cell. Sheet heaters may also be placed in the gaps between the battery cells.

With continued reference to FIG. 2, temperature regulating element 244 may include a cooling element. As used in the current disclosure, a “cooling element” is a device used to lower the temperature of the battery or cabin. In an embodiment, a cooling element may include a fan, air conditioner, the use of coolant, heat exchangers. Cool air may be forced into the cabin or battery as a function of the target temperature.

With continued reference to FIG. 2, flexible duct hose 256 may include a Coolant flow path. In some embodiments, coolant flow path may have a distal end located substantially at charging connector 212. As used in this disclosure, a “coolant flow path” is a component that is substantially impermeable to a coolant and contains and/or directs a coolant flow. As used in this disclosure, “coolant” is any flowable heat transfer medium. Coolant may include a liquid, a gas, a solid, and/or a fluid. Coolant may include a compressible fluid and/or a non-compressible fluid. Coolant may include a non-electrically conductive liquid such as a fluorocarbon-based fluid, such as without limitation Fluorinert™ from 3M of Saint Paul, Minnesota, USA. In some cases, coolant may include air. As used in this disclosure, a “flow of coolant” is a stream of coolant. In some cases, coolant may include a fluid and coolant flow is a fluid flow. Alternatively or additionally, in some cases, coolant may include a solid (e.g., bulk material) and coolant flow may include motion of the solid. Exemplary forms of mechanical motion for bulk materials include fluidized flow, augers, conveyors, slumping, sliding, rolling, and the like. Coolant flow path may be in fluidic communication with a Coolant source. As used in this disclosure, a “coolant source” is an origin, generator, reservoir, or flow producer of coolant. In some cases, a coolant source may include a flow producer, such as a fan and/or a pump. Coolant source may include any of following non-limiting examples, air conditioner, refrigerator, heat exchanger, pump, fan, expansion valve, and the like.

Still referring to FIG. 2, in some embodiments, Coolant source may be further configured to transfer heat between coolant, for example coolant belonging to coolant flow, and an ambient air. As used in this disclosure, “ambient air” is air which is proximal a system and/or subsystem, for instance the air in an environment which a system and/or sub-system is operating. For example, in some cases, Coolant source comprises a heart transfer device between coolant and ambient air. Exemplary heat transfer devices include, without limitation, chillers, Peltier junctions, heat pumps, refrigeration, air conditioning, expansion or throttle valves, heat exchangers (air-to-air heat exchangers, air-to-liquid heat exchangers, shell-tube heat exchangers, and the like), vapor-compression cycle system, vapor absorption cycle system, gas cycle system, Stirling engine, reverse Carnot cycle system, and the like. In some versions, computing device 240 may be further configured to control a temperature of coolant. For instance, in some cases, a sensor may be located within thermal communication with coolant, such that sensor is able to detect, measure, or otherwise quantify temperature of coolant within a certain acceptable level of precision. In some cases, sensor may include a thermometer. Exemplary thermometers include without limitation, pyrometers, infrared non-contacting thermometers, thermistors, thermocouples, and the like. In some cases, thermometer may transduce coolant temperature to a coolant temperature signal and transmit the coolant temperature signal to computing device 240. Computing device 240 may receive coolant temperature signal and control heat transfer between ambient air and coolant as a function of the coolant temperature signal. Computing device 240 may use any control method and/or algorithm used in this disclosure to control heat transfer, including without limitation proportional control, proportional-integral control, proportional-integral-derivative control, and the like. In some cases, computing device 240 may be further configured to control temperature of coolant within a temperature range below an ambient air temperature. As used in this disclosure, an “ambient air temperature” is temperature of an ambient air. An exemplary non-limiting temperature range below ambient air temperature is about −5° C. to about −30° C. In some embodiments, coolant flow may substantially be comprised of air. In some cases, coolant flow may have a rate within a range a specified range. A non-limiting exemplary coolant flow range may be about 0.1 CFM and about 100 CFM. In some cases, rate of coolant flow may be considered as a volumetric flow rate. Alternatively or additionally, rate of coolant flow may be considered as a velocity or flux. In some embodiments, coolant source may be further configured to transfer heat between a heat source, such as without limitation ambient air or chemical energy, such as by way of combustion, and coolant, for example coolant flow. In some cases, coolant source may heat coolant, for example above ambient air temperature, and/or cool coolant, for example below an ambient air temperature. In some cases, coolant source may be powered by electricity, such as by way of one or more electric motors. Alternatively or additionally, coolant source may be powered by a combustion engine, for example a gasoline powered internal combustion engine. In some cases, coolant flow may be configured, such that heat transfer is facilitated between coolant flow and at least a battery, by any methods known and/or described in this disclosure. In some cases, at least a battery may include a plurality of pouch cells. In some cases, heat is transferred between coolant flow and one or more components of at least a pouch cell, including without limitation electrical tabs, pouch, and the like. In some cases, coolant flow may be configured to facilitate heat transfer between the coolant flow and at least a conductor of electric vehicle, including without limitation electrical busses within at least a battery. Coolant flow path and coolant reservoir may be a combination of the coolant flow path and coolant reservoir utilized to in U.S. Nonprovisional application Ser. No. 17/563,383 (Attorney Docket No. 1024-319USU1), filed on Dec. 28, 2021, and entitled “SYSTEM FOR BATTER TEMPERATURE MANAGEMENT IN AN ELECTRIC AIRCRAFT”, the entirety of which is incorporated herein by reference.

With continued reference to FIG. 2, in some embodiments, at least a sensor 248 is configured to detect collect temperature datum 252 from the battery. For the purposes of this disclosure, “temperature datum” is an electronic signal representing an information and/or a parameter of a detected electrical and/or physical characteristic and/or phenomenon correlated with the temperature within the battery or the cabin of the electric aircraft. Temperature datum may also include a measurement of resistance, current, voltage, moisture, and the current temperature of the battery. Temperature datum 252 may also include information regarding the degradation or failure of the battery cell. In some cases, at least a sensor 248 may include a coolant temperature sensor, wherein the coolant temperature sensor is configured to generate a coolant temperature datum as a function of the coolant temperature. In some cases, at least a sensor 248 may contain more than one sensor wherein a coolant or a first temperature sensor may be configured to generate a coolant temperature datum as a function of a coolant temperature and a second temperature sensor or a second coolant temperature sensor may be configured to generate a second coolant temperature datum representing a second coolant temperature. In some cases a first coolant temperature sensor may be representative of a first coolant temperature and a second coolant temperature sensor may be representative of a second coolant. In some cases, first coolant temperature may be used to indicate the temperature of a battery on electric aircraft. In some cases, second coolant temperature may be used to indicate the temperature within a passenger cabin on an electric aircraft.

Still referring to FIG. 2, as used in this disclosure, a “sensor” is a device that is configured to detect a phenomenon and transmit information related to the detection of the phenomenon. For example, in some cases a sensor may transduce a detected phenomenon, such as without limitation, voltage, current, speed, direction, force, torque, resistance, moisture, temperature, pressure, and the like, into a sensed signal. Sensor may include one or more sensors which may be the same, similar, or different. Sensor may include a plurality of sensors which may be the same, similar, or different. Sensor may include one or more sensor suites with sensors in each sensor suite being the same, similar, or different.

Still referring to FIG. 2, sensor(s) 248 may include any number of suitable sensors which may be efficaciously used to detect temperature datum 252. For example, and without limitation, these sensors may include a voltage sensor, current sensor, multimeter, voltmeter, ammeter, electrical current sensor, resistance sensor, impedance sensor, capacitance sensor, a Wheatstone bridge, displacements sensor, vibration sensor, Daly detector, electroscope, electron multiplier, Faraday cup, galvanometer, Hall effect sensor, Hall probe, magnetic sensor, optical sensor, magnetometer, magnetoresistance sensor, MEMS magnetic field sensor, metal detector, planar Hall sensor, thermal sensor, and the like, among others. Sensor(s) 248 may efficaciously include, without limitation, any of the sensors disclosed in the entirety of the present disclosure.

With continued reference to FIG. 2, in some embodiments of charging station 200, Sensor 248 may be communicatively connected with a Computing device 240. Sensor 248 may communicate with Computing device 240 using an electric connection. Alternatively, Sensor 248 may communicate with Computing device 240 wirelessly, such as by radio waves, Bluetooth, or Wi-Fi. One of ordinary skill in the art, upon reviewing the entirety of this disclosure, would recognize that a variety of wireless communication technologies are suitable for this application.

With continued reference to FIG. 2, Computing device 240 may be communicatively connected with temperature regulating elements 244. Computing device 240 may be configured to receive temperature datum 252 from Sensor 248. High/low temperature within the battery cell may be determined by the Computing device 240 as a function of the temperature datum 252. Additionally, the computing device may determine high/low temperature within the battery cells by comparing temperature datum 252 to a predetermined value. When Computing device 240 receives temperature datum 252 from Sensor 248 that indicates high/low temperature within the battery cells, then Computing device 240 may send a may send a notification to a user interface signifying that high/low temperature within the battery cells.

Referring now to FIG. 3, a block diagram for an exemplary charging station 300 with multiple cable reel modules 216. Charging station 300 may depict a plurality of cable reel modules a charging reel 304, Battery Reel 308, and a cabin reel 316. As used in the current disclosure, a “charging reel” may be a cable reel module 216 that is outfitted with equipment that is designed to charge the battery of the electric aircraft. That equipment may include an energy source 252, charging connector 212, and Charging cable 208. In some embodiments, the disclosure of charging reel 304 is consistent with the disclosure of the cable reel module 216 of FIG. 2.

Still referring to FIG. 3, a block diagram for an exemplary charging station 300 with a Battery Reel 308. As used in the current disclosure, a “battery reel” may be a cable reel module 216 that is configured to house a temperature regulating element 244. The battery reel 308 may be designed to regulate the temperature of the battery of electric aircraft 316. Battery reel 308 may include a sensor 248, temperature datum 252, a computing device 240, Flexible duct hose 256, and a temperature regulating element 244. A temperature sensor within a battery reel may be configured to generate temperature datum regarding the battery 320. A flexible duct hose 256 may be wrapped around the reel of battery reel 308. A flexible duct hose 256 may be mechanically connected to a temperature regulating element.

Still referring to FIG. 3, a block diagram for an exemplary charging station 300 with a Cabin Reel 312. As used in the current disclosure, a “cabin reel” may be a cable reel module 216 that is configured to house a temperature regulating element 244. The cabin reel 312 may be designed to regulate the temperature of the cabin of electric aircraft 316. Cabin reel 312 may include a sensor 248, temperature datum 252, a computing device 240, Flexible duct hose 256, and a temperature regulating element 244. A temperature sensor within a cabin reel 312 may be configured to generate temperature datum regarding the cabin 324. A flexible duct hose 256 may be wrapped around the reel of cabin reel 312. A flexible duct hose 256 may be mechanically connected to a temperature regulating element. In some embodiments, the disclosure of a battery reel 308 and a cabin reel 312 may be consistent with each other.

With continued reference to FIG. 3, the term “electric aircraft,” for the purposes of this disclosure, refers to a machine that is able to fly by gaining support from the air generates substantially all of its trust from electricity. As a non-limiting example, electric aircraft 316 may be capable of vertical takeoff and landing (VTOL) or conventional takeoff and landing (CTOL). As another non-limiting example, the electric aircraft may be capable of both VTOL and CTOL. As a non-limiting example, electric aircraft may be capable of edgewise flight. As a non-limiting example, electric aircraft 316 may be able to hover. Electric aircraft 316 may include a variety of electric propulsion devices; including, as non-limiting examples, pushers, pullers, lift devices, and the like.

With continued reference to FIG. 3, the term ‘battery’ is used as a collection of cells connected in series or parallel to each other. A battery cell 320, when used in conjunction with other cells, may be electrically connected in series, in parallel or a combination of series and parallel. Series connection comprises wiring a first terminal of a first cell to a second terminal of a second cell and further configured to comprise a single conductive path for electricity to flow while maintaining the same current (measured in Amperes) through any component in the circuit. A battery cell 320 may use the term ‘wired’, but one of ordinary skill in the art would appreciate that this term is synonymous with ‘electrically connected’, and that there are many ways to couple electrical elements like battery cells together. An example of a connector that do not comprise wires may be prefabricated terminals of a first gender that mate with a second terminal with a second gender. Battery cells 320 may be wired in parallel. Parallel connection comprises wiring a first and second terminal of a first battery cell 320 to a first and second terminal of a second battery cell 320 and further configured to comprise more than one conductive path for electricity to flow while maintaining the same voltage (measured in Volts) across any component in the circuit. Battery cells 320 may be wired in a series-parallel circuit which combines characteristics of the constituent circuit types to this combination circuit. Battery cells 320 may be electrically connected in a virtually unlimited arrangement which may confer onto the system the electrical advantages associated with that arrangement such as high-voltage applications, high-current applications, or the like. In an exemplary embodiment, Battery module comprise 196 battery cells 320 in series and 18 battery cells in parallel. This is, as someone of ordinary skill in the art would appreciate, is only an example and Battery module may be configured to have a near limitless arrangement of battery cell 320 configurations.

With continued reference to FIG. 3, a plurality of battery modules may also comprise a side wall which comprises a laminate of a plurality of layers configured to thermally insulate the plurality of battery cells 320 from external components of battery module. Side wall layers may comprise materials which possess characteristics suitable for thermal insulation as described in the entirety of this disclosure like fiberglass, air, iron fibers, polystyrene foam, and thin plastic films, to name a few. Side wall may additionally or alternatively electrically insulate the plurality of battery cells 320 from external components of battery module and the layers of which may comprise polyvinyl chloride (PVC), glass, asbestos, rigid laminate, varnish, resin, paper, Teflon, rubber, and mechanical lamina. Center sheet may be mechanically coupled to side wall in any manner described in the entirety of this disclosure or otherwise undisclosed methods, alone or in combination. Side wall may comprise a feature for alignment and coupling to center sheet. This feature may comprise a cutout, slots, holes, bosses, ridges, channels, and/or other undisclosed mechanical features, alone or in combination. Plurality of battery module may be a combination of a plurality of battery module utilized to power the electric aircraft. Battery module may include any of the batteries described in U.S. Nonprovisional application Ser. No. 16/948,140, filed on Sep. 4, 2020, and entitled “SYSTEM AND METHOD FOR HIGH ENERGY DENSITY BATTERY MODULE”, the entirety of which is incorporated herein by reference.

With continued reference to FIG. 3, the term “cabin,” for the purposes of this disclosure, refers to the area within the fuselage of the aircraft where the pilot and passengers are seated. The cabin 324 may also include areas where the payload of the aircraft is stored. Additionally, the cabin 324 of the aircraft may be any enclosed space within the aircraft that is habitable during flight.

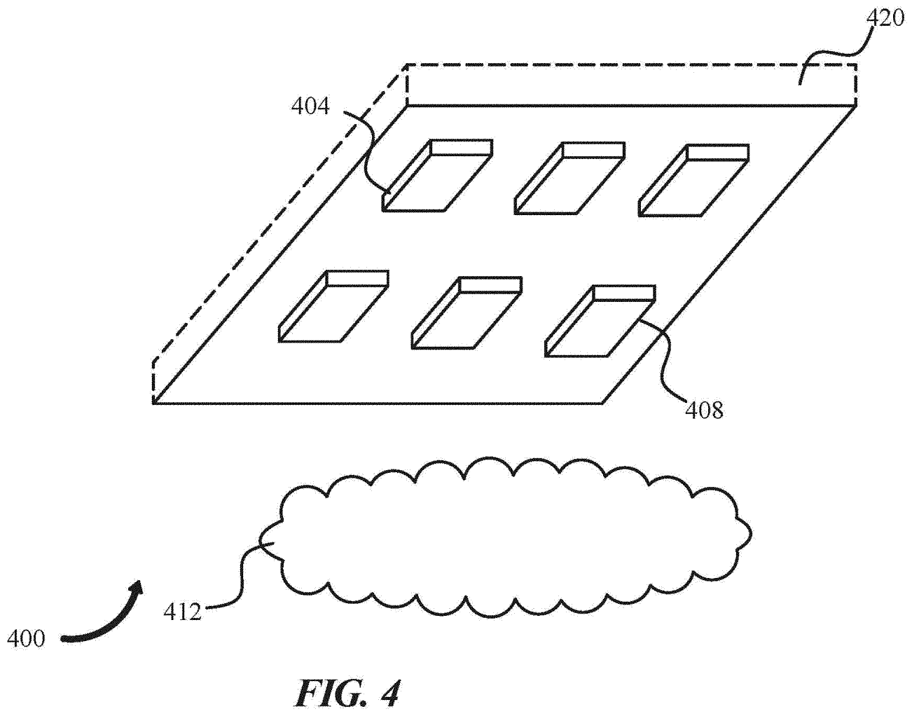

Referring now to FIG. 4, an embodiment of sensor suite 400 is presented. The herein disclosed system and method may include a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In a non-limiting example, there may be four independent sensors housed in and/or on battery pack 124 measuring temperature, electrical characteristic such as voltage, amperage, resistance, or impedance, or any other parameters and/or quantities as described in this disclosure. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of battery management system 100 and/or user to detect phenomenon is maintained and in a non-limiting example, a user alter aircraft usage pursuant to sensor readings.

Sensor suite 400 may be suitable for use as first sensor suite 104 and/or second sensor suite 116 as disclosed with reference to FIG. 1 hereinabove. Sensor suite 400 may include a moisture sensor 404. “Moisture”, as used in this disclosure, is the presence of water, this may include vaporized water in air, condensation on the surfaces of objects, or concentrations of liquid water. Moisture may include humidity. “Humidity”, as used in this disclosure, is the property of a gaseous medium (almost always air) to hold water in the form of vapor. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. Moisture sensor 404 may be psychrometer. Moisture sensor 404 may be a hygrometer. Moisture sensor 404 may be configured to act as or include a humidistat. A “humidistat”, for the purposes of this disclosure, is a humidity-triggered switch, often used to control another electronic device. Moisture sensor 404 may use capacitance to measure relative humidity and include in itself, or as an external component, include a device to convert relative humidity measurements to absolute humidity measurements. “Capacitance”, for the purposes of this disclosure, is the ability of a system to store an electric charge, in this case the system is a parcel of air which may be near, adjacent to, or above a battery cell.

With continued reference to FIG. 4, sensor suite 400 may include electrical sensors 408. Electrical sensors 408 may be configured to measure voltage across a component, electrical current through a component, and resistance of a component. Electrical sensors 408 may include separate sensors to measure each of the previously disclosed electrical characteristics such as voltmeter, ammeter, and ohmmeter, respectively.

Alternatively or additionally, and with continued reference to FIG. 4, sensor suite 400 include a sensor or plurality thereof that may detect voltage and direct the charging of individual battery cells according to charge level; detection may be performed using any suitable component, set of components, and/or mechanism for direct or indirect measurement and/or detection of voltage levels, including without limitation comparators, analog to digital converters, any form of voltmeter, or the like. Sensor suite 400 and/or a control circuit incorporated therein and/or communicatively connected thereto may be configured to adjust charge to one or more battery cells as a function of a charge level and/or a detected parameter. For instance, and without limitation, sensor suite 400 may be configured to determine that a charge level of a battery cell is high based on a detected voltage level of that battery cell or portion of the battery pack. Sensor suite 400 may alternatively or additionally detect a charge reduction event, defined for purposes of this disclosure as any temporary or permanent state of a battery cell requiring reduction or cessation of charging; a charge reduction event may include a cell being fully charged and/or a cell undergoing a physical and/or electrical process that makes continued charging at a current voltage and/or current level inadvisable due to a risk that the cell will be damaged, will overheat, or the like. Detection of a charge reduction event may include detection of a temperature, of the cell above a threshold level, detection of a voltage and/or resistance level above or below a threshold, or the like. Sensor suite 400 may include digital sensors, analog sensors, or a combination thereof. Sensor suite 400 may include digital-to-analog converters (DAC), analog-to-digital converters (ADC, A/D, A-to-D), a combination thereof, or other signal conditioning components used in transmission of a first plurality of battery pack data 128 to a destination over wireless or wired connection.

With continued reference to FIG. 4, sensor suite 400 may include thermocouples, thermistors, thermometers, passive infrared sensors, resistance temperature sensors (RTDs), semiconductor based integrated circuits (IC), a combination thereof or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor suite 400, may be measured in Fahrenheit (° F.), Celsius (° C.), Kelvin (° K), or another scale alone or in combination. The temperature measured by sensors may comprise electrical signals which are transmitted to their appropriate destination wireless or through a wired connection.

With continued reference to FIG. 4, sensor suite 400 may include a sensor configured to detect gas that may be emitted during or after a cell failure. “Cell failure”, for the purposes of this disclosure, refers to a malfunction of a battery cell, which may be an electrochemical cell, that renders the cell inoperable for its designed function, namely providing electrical energy to at least a portion of an electric aircraft. Byproducts of cell failure 412 may include gaseous discharge including oxygen, hydrogen, carbon dioxide, methane, carbon monoxide, a combination thereof, or another undisclosed gas, alone or in combination. Further the sensor configured to detect vent gas from electrochemical cells may comprise a gas detector. For the purposes of this disclosure, a “gas detector” is a device used to detect a gas is present in an area. Gas detectors, and more specifically, the gas sensor that may be used in sensor suite 400, may be configured to detect combustible, flammable, toxic, oxygen depleted, a combination thereof, or another type of gas alone or in combination. The gas sensor that may be present in sensor suite 400 may include a combustible gas, photoionization detectors, electrochemical gas sensors, ultrasonic sensors, metal-oxide-semiconductor (MOS) sensors, infrared imaging sensors, a combination thereof, or another undisclosed type of gas sensor alone or in combination. Sensor suite 400 may include sensors that are configured to detect non-gaseous byproducts of cell failure 412 including, in non-limiting examples, liquid chemical leaks including aqueous alkaline solution, ionomer, molten phosphoric acid, liquid electrolytes with redox shuttle and ionomer, and salt water, among others. Sensor suite 400 may include sensors that are configured to detect non-gaseous byproducts of cell failure 412 including, in non-limiting examples, electrical anomalies as detected by any of the previous disclosed sensors or components.

With continued reference to FIG. 4, sensor suite 400 may be configured to detect events where voltage nears an upper voltage threshold or lower voltage threshold. The upper voltage threshold may be stored in data storage system 120 for comparison with an instant measurement taken by any combination of sensors present within sensor suite 400. The upper voltage threshold may be calculated and calibrated based on factors relating to battery cell health, maintenance history, location within battery pack, designed application, and type, among others. Sensor suite 400 may measure voltage at an instant, over a period of time, or periodically. Sensor suite 400 may be configured to operate at any of these detection modes, switch between modes, or simultaneous measure in more than one mode. First battery management component 104 may detect through sensor suite 400 events where voltage nears the lower voltage threshold. The lower voltage threshold may indicate power loss to or from an individual battery cell or portion of the battery pack. First battery management component 104 may detect through sensor suite 400 events where voltage exceeds the upper and lower voltage threshold. Events where voltage exceeds the upper and lower voltage threshold may indicate battery cell failure or electrical anomalies that could lead to potentially dangerous situations for aircraft and personnel that may be present in or near its operation.

Still referring to FIG. 4, sensor suite 400 may include a fuzzy inference system. “Fuzzy inference” is the process of formulating a mapping from a given input to an output using fuzzy logic. “Fuzzy logic” is a form of many-valued logic in which the truth value of variables may be any real number between 0 and 1. Fuzzy logic may be employed to handle the concept of partial truth, where the truth value may range between completely true and completely false. The mapping of a given input to an output using fuzzy logic may provide a basis from which decisions may be made and/or patterns discerned. A first fuzzy set may be represented, without limitation, according to a first membership function representing a probability that an input falling on a first range of values is a member of the first fuzzy set, where the first membership function has values on a range of probabilities such as without limitation the interval [0,1], and an area beneath the first membership function may represent a set of values within the first fuzzy set. A first membership function may include any suitable function mapping a first range to a probability interval, including without limitation a triangular function defined by two linear elements such as line segments or planes that intersect at or below the top of the probability interval.

Still referring to FIG. 4, a first fuzzy set may represent any value or combination of values as described above, including charging data, environment data, and/or any combination of the above. A second fuzzy set, which may represent any value which may be represented by first fuzzy set, may be defined by a second membership function on a second range; second range may be identical and/or overlap with first range and/or may be combined with first range via Cartesian product or the like to generate a mapping permitting evaluation overlap of first fuzzy set and second fuzzy set. Where first fuzzy set and second fuzzy set have a region that overlaps, first membership function and second membership function may intersect at a point representing a probability, as defined on probability interval, of a match between first fuzzy set and second fuzzy set. Alternatively or additionally, a single value of first and/or second fuzzy set may be located at a locus on a first range and/or a second range, where a probability of membership may be taken by evaluation of a first membership function and/or a second membership function at that range point. A probability may be compared to a threshold to determine whether a positive match is indicated. A threshold may, in a non-limiting example, represent a degree of match between a first fuzzy set and a second fuzzy set, and/or single values therein with each other or with either set, which is sufficient for purposes of the matching process. In some embodiments, there may be multiple thresholds. Each threshold may be established by one or more user inputs. Alternatively or additionally, each threshold may be tuned by a machine-learning and/or statistical process, for instance and without limitation as described in further detail below.

Still referring to FIG. 4, sensor suite 400 may use a fuzzy inference system to determine a plurality of outputs based on a plurality of inputs. A plurality of outputs may include, but is not limited to, overheating, low air flow, poor air quality, gas leaks, and the like. As a non-limiting example, sensor suite 400 may measure “high temperature” and “low air flow”. Sensor suite 400 may determine, using a fuzzy inference system, that a ventilation system is “off”. In another non-limiting example, sensor suite 400 may measure “high voltage” of a recharging component and “high gas particulate concentration” surrounding the recharging component. Sensor suite 400 may determine, using a fuzzy inference system, that recharging environment conditions are “poor”. In some embodiments, sensor suite 400 may use a fuzzy inference system to determine one or more states of one or more exhaust devices, such as, but not limited to, a fan speed. In some embodiments, sensor suite 400 may use a fuzzy inference system to determine a state of a recharging component, such as, but not limited to, charging, off, standby, error, overload, and the like.

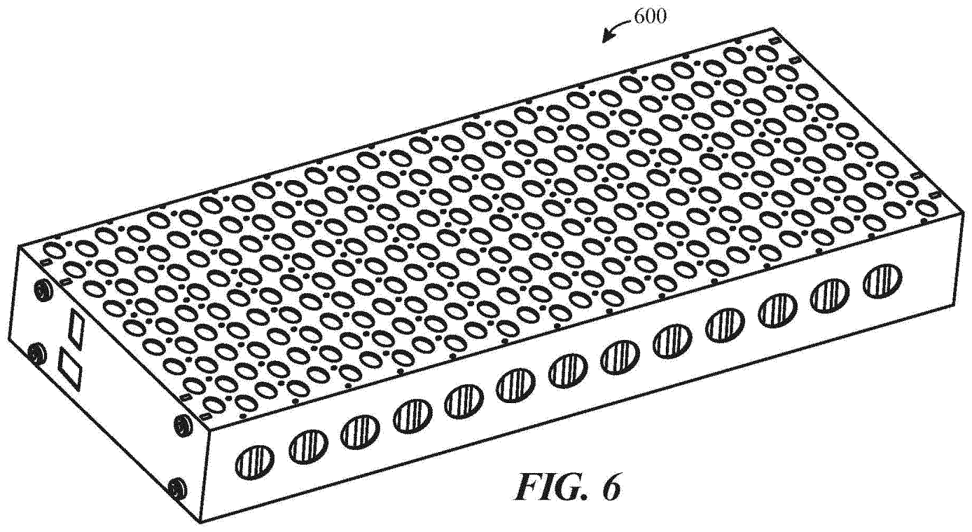

Referring now to FIG. 5, an illustration of an exemplary embodiment of an electric aircraft 500 is shown. As previously mentioned in this disclosure, electric vehicle 104 may include an electric aircraft, such as electric aircraft 500. Electric aircraft 500 may include an electric vertical takeoff and landing aircraft (eVTOL). As used herein, a vertical take-off and landing (eVTOL) aircraft is one that may hover, take off, and land vertically. An eVTOL, as used herein, is an electrically powered aircraft typically using an energy source, of a plurality of energy sources to power the aircraft. In one or more embodiments, electric aircraft 500 may include a recharging component, such as a port 512. In various embodiments, port 512 may communicatively connect to a component of a charging station, such as a connector, so that electric power may be transferred between charging station and energy source of electric aircraft 500. For example, and without limitation, electrical power may be transferred from the charging station, through port 512, and to energy source of electric aircraft 500. Electrical power transferred through port 512 may recharge energy source of electric aircraft, such as a battery pack that may include one or more battery modules with one or more battery cells, which are discussed further in FIG. 6. In one or more embodiments, connector of charging station may mechanically connect to port 512 of electric aircraft 500. In order to optimize the power and energy necessary to propel the aircraft. An eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 5, a number of aerodynamic forces may act upon the electric aircraft 500 during flight. Forces acting on an electric aircraft 500 during flight may include, without limitation, thrust, the forward force produced by the rotating element of the electric aircraft 500 and acts parallel to the longitudinal axis. Another force acting upon electric aircraft 500 may be, without limitation, drag, which may be defined as a rearward retarding force which is caused by disruption of airflow by any protruding surface of the electric aircraft 500 such as, without limitation, the wing, rotor, and fuselage. Drag may oppose thrust and acts rearward parallel to the relative wind. A further force acting upon electric aircraft 500 may include, without limitation, weight, which may include a combined load of the electric aircraft 500 itself, crew, baggage, and/or fuel. Weight may pull electric aircraft 500 downward due to the force of gravity. An additional force acting on electric aircraft 500 may include, without limitation, lift, which may act to oppose the downward force of weight and may be produced by the dynamic effect of air acting on the airfoil and/or downward thrust from the propulsor of the electric aircraft. Lift generated by the airfoil may depend on speed of airflow, density of air, total area of an airfoil and/or segment thereof, and/or an angle of attack between air and the airfoil. For example, and without limitation, electric aircraft 500 are designed to be as lightweight as possible. Reducing the weight of the aircraft and designing to reduce the number of components is essential to optimize the weight. To save energy, it may be useful to reduce weight of components of an electric aircraft 500, including without limitation propulsors and/or propulsion assemblies. In an embodiment, the motor may eliminate need for many external structural features that otherwise might be needed to join one component to another component. The motor may also increase energy efficiency by enabling a lower physical propulsor profile, reducing drag and/or wind resistance. This may also increase durability by lessening the extent to which drag and/or wind resistance add to forces acting on electric aircraft 500 and/or propulsors.

Referring still to FIG. 5, electric aircraft 500 may include at least a vertical propulsor 504 and at least a forward propulsor 508. A forward propulsor is a propulsor that propels the aircraft in a forward direction. Forward in this context is not an indication of the propulsor position on the aircraft; one or more propulsors mounted on the front, on the wings, at the rear, etc. A vertical propulsor is a propulsor that propels the aircraft in an upward direction; one of more vertical propulsors may be mounted on the front, on the wings, at the rear, and/or any suitable location. A propulsor, as used herein, is a component or device used to propel a craft by exerting force on a fluid medium, which may include a gaseous medium such as air or a liquid medium such as water. At least a vertical propulsor 504 is a propulsor that generates a substantially downward thrust, tending to propel an aircraft in a vertical direction providing thrust for maneuvers such as without limitation, vertical take-off, vertical landing, hovering, and/or rotor-based flight such as “quadcopter” or similar styles of flight.

With continued reference to FIG. 5, at least a forward propulsor 508 as used in this disclosure is a propulsor positioned for propelling an aircraft in a “forward” direction; at least a forward propulsor may include one or more propulsors mounted on the front, on the wings, at the rear, or a combination of any such positions. At least a forward propulsor may propel an aircraft forward for fixed-wing and/or “airplane”-style flight, takeoff, and/or landing, and/or may propel the aircraft forward or backward on the ground. At least a vertical propulsor 504 and at least a forward propulsor 508 includes a thrust element. At least a thrust element may include any device or component that converts the mechanical energy of a motor, for instance in the form of rotational motion of a shaft, into thrust in a fluid medium. At least a thrust element may include, without limitation, a device using moving or rotating foils, including without limitation one or more rotors, an airscrew or propeller, a set of airscrews or propellers such as contrarotating propellers, a moving or flapping wing, or the like. At least a thrust element may include without limitation a marine propeller or screw, an impeller, a turbine, a pump-jet, a paddle or paddle-based device, or the like. As another non-limiting example, at least a thrust element may include an eight-bladed pusher propeller, such as an eight-bladed propeller mounted behind the engine to ensure the drive shaft is in compression. Propulsors may include at least a motor mechanically coupled to the at least a first propulsor as a source of thrust. A motor may include without limitation, any electric motor, where an electric motor is a device that converts electrical energy into mechanical energy, for instance by causing a shaft to rotate. At least a motor may be driven by direct current (DC) electric power; for instance, at least a first motor may include a brushed DC at least a first motor, or the like. At least a first motor may be driven by electric power having varying or reversing voltage levels, such as alternating current (AC) power as produced by an alternating current generator and/or inverter, or otherwise varying power, such as produced by a switching power source. At least a first motor may include, without limitation, brushless DC electric motors, permanent magnet synchronous at least a first motor, switched reluctance motors, or induction motors. In addition to inverter and/or a switching power source, a circuit driving at least a first motor may include electronic speed controllers or other components for regulating motor speed, rotation direction, and/or dynamic braking. Persons skilled in the art, upon reviewing the entirety of this disclosure, will be aware of various devices that may be used as at least a thrust element.

With continued reference to FIG. 5, during flight, a number of forces may act upon electric aircraft 500. Forces acting on electric aircraft 500 during flight may include thrust, the forward force produced by the rotating element of electric aircraft 500 and acts parallel to the longitudinal axis. Drag may be defined as a rearward retarding force which is caused by disruption of airflow by any protruding surface of electric aircraft 500 such as, without limitation, the wing, rotor, and fuselage. Drag may oppose thrust and acts rearward parallel to the relative wind. Another force acting on electric aircraft 500 may include weight, which may include a combined load of the aircraft 500 itself, crew, baggage and fuel. Weight may pull electric aircraft 500 downward due to the force of gravity. An additional force acting on electric aircraft 500 may include lift, which may act to oppose the downward force of weight and may be produced by the dynamic effect of air acting on the airfoil and/or downward thrust from at least a propulsor. Lift generated by the airfoil may depends on speed of airflow, density of air, total area of an airfoil and/or segment thereof, and/or an angle of attack between air and the airfoil.

Referring now to FIG. 6, an exemplary embodiment of battery module 600 is illustrated. In embodiments, each circle illustrated represents a battery cell's circular cross-section. A battery cell, which will be adequately described below may take a plurality of forms, but for the purposes of these illustrations and disclosure, will be represented by a cylinder, with circles in representing the cross section of one cell each. With this orientation, a cylindrical battery cell has a long axis not visible in illustration. Battery cells are disposed in a staggered arrangement, with one battery unit including two columns of staggered cells. Each battery unit includes at least the cell retainer including a sheet of material with holes in a staggered pattern corresponding to the staggered orientation of cells. Cell retainer is the component which fixes the battery cells in their orientation amongst the entirety of the battery module. Cell retainer also includes two columns of staggered holes corresponding to the battery cells. There is the cell guide disposed between each set of two columns of the battery cells underneath the cell retainer. Battery module can include a protective wrapping which weaves in between the two columns of the battery cells contained in a battery unit.

With continued reference to FIG. 6, battery module 600 may include a sense board, a side panel, an end cap, electrical bus, and openings are presented. In an embodiment, a sense board is illustrated in its entirety. A sense board may include at least a portion of a circuit board that includes one or more sensors configured to measure the temperature of the battery cells disposed within battery module 600. In embodiments, sensor board may include one or more openings disposed in rows and column on a surface of sense board. In embodiments, each hole may correspond to the battery cells disposed within, encapsulated, at least in part, by battery units. For example, the location of each hole may correspond to the location of each battery cell disposed within battery module 600.

Referring still to FIG. 6, according to embodiment, battery module 600 can include one or more side panels. A side panel can include a protective layer of material configured to create a barrier between internal components of battery module 600 and other aircraft components or environment. A side panel may include opposite and opposing faces that form a side of and encapsulate at least a portion of battery module 600. A side panel may include metallic materials like aluminum, aluminum alloys, steel alloys, copper, tin, titanium, another undisclosed material, or a combination thereof. A side panel may not preclude use of nonmetallic materials alone or in combination with metallic components permanently or temporarily coupled together. Nonmetallic materials that may be used alone or in combination in the construction of a side panel may include high density polyethylene (HDPE), polypropylene, polycarbonate, acrylonitrile butadiene styrene, polyethylene, nylon, polystyrene, polyether ether ketone, to name a few. A side panel may be manufactured by a number of processes alone or in combination, including but limited to, machining, milling, forging, casting, 5D printing (or other additive manufacturing methods), turning, or injection molding, to name a few. One of ordinary skill in the art would appreciate that a side panel may be manufactured in pieces and assembled together by screws, nails, rivets, dowels, pins, epoxy, glue, welding, crimping, or another undisclosed method alone or in combination. A side panel may be coupled to sense board, the back plate, and/or an end cap through standard hardware like a bolt and nut mechanism, for example.

With continued reference to FIG. 6, battery module 600 may also include one or more end caps. An end cap may include a nonconductive component configured to align the back plate, sense board, and internal battery components of battery module 600 and hold their position. An end cap may form and end of and encapsulate a portion of a first end of battery module 600 and a second opposite and opposing end cap may form a second end and encapsulate a portion of a second end of battery module 600. An end cap may include a snap attachment mechanism further including a protruding boss which can configured to be captured, at least in part by a receptable of a corresponding size, by a receptacle disposed in or on the back plate. An end cap may employ a similar or same method for coupling itself to sense board, which may include a similar or the same receptacle. One or ordinary skill in the art would appreciate that the embodiments of a quick attach/detach mechanism end cap is only an example and any number of mechanisms and methods may be used for this purpose. It should also be noted that other mechanical coupling mechanisms may be used that are not necessarily designed for quick removal. Said mechanical coupling may include, as a non-limiting example, rigid coupling (e.g. beam coupling), bellows coupling, bushed pin coupling, constant velocity, split-muff coupling, diaphragm coupling, disc coupling, donut coupling, elastic coupling, flexible coupling, fluid coupling, gear coupling, grid coupling, hirth joints, hydrodynamic coupling, jaw coupling, magnetic coupling, Oldham coupling, sleeve coupling, tapered shaft lock, twin spring coupling, rag joint coupling, universal joints, or any combination thereof. An end cap may include a nonconductive component manufactured from or by a process that renders it incapable or unsuitable for conveying electrical through, on, or over it. Nonconductive materials an end cap may include may be paper, Teflon, glass, rubber, fiberglass, porcelain, ceramic, quartz, various plastics like HDPE, ABS, among others alone or in combination.

Still referring to FIG. 6, an end cap may include an electrical bus. An electrical bus, for the purposes of this disclosure and in electrical parlance is any common connection to which any number of loads, which may be connected in parallel, and share a relatively similar voltage may be electrically coupled. Electrical bus may refer to power busses, audio busses, video busses, computing address busses, and/or data busses. Electrical bus may be responsible for conveying electrical energy stored in battery module 600 to at least a portion of an eVTOL aircraft. The same or a distinct electrical bus may additionally or alternatively responsible for conveying electrical signals generated by any number of components within battery module 600 to any destination on or offboard an eVTOL aircraft. An end cap may include wiring or conductive surfaces only in portions required to electrically couple electrical bus to electrical power or necessary circuits to convey that power or signals to their destinations.

Still referring to FIG. 6, and in embodiments, a battery module with multiple battery units is illustrated, according to embodiments. Battery module 600 may include a battery cell, the cell retainer, a cell guide, a protective wrapping, a back plate, an end cap, and a side panel. Battery module 600 may include a plurality of the battery cells. In embodiments, the battery cells may be disposed and/or arranged within a respective battery unit in groupings of any number of columns and rows. For example, in the illustrative embodiment of FIG. 6, the battery cells are arranged in each respective battery unit with 18 cells in two columns. It should be noted that although the illustration may be interpreted as containing rows and columns, that the groupings of the battery cells in a battery unit, that the rows are only present as a consequence of the repetitive nature of the pattern of staggered the battery cells and battery cell holes in the cell retainer being aligned in a series. While in the illustrative embodiment of FIG. 6 the battery cells are arranged 18 to a battery unit with a plurality of battery units including battery module 600, one of skill in the art will understand that the battery cells may be arranged in any number to a row and in any number of columns and further, any number of battery units may be present in battery module 600. According to embodiments, the battery cells within a first column may be disposed and/or arranged such that they are staggered relative to the battery cells within a second column. In this way, any two adjacent rows of the battery cells may not be laterally adjacent but instead may be respectively offset a predetermined distance. In embodiments, any two adjacent rows of the battery cells may be offset by a distance equal to a radius of a battery cell. This arrangement of the battery cells is only a non-limiting example and in no way preclude other arrangement of the battery cells.

Battery module 600 may also include a protective wrapping woven between the plurality of the battery cells. Protective wrapping may provide fire protection, thermal containment, and thermal runaway during a battery cell malfunction or within normal operating limits of one or more the battery cells and/or potentially, battery module 600 as a whole. Battery module 600 may also include a backplate. A backplate is configured to provide structure and encapsulate at least a portion of the battery cells, the cell retainers, the cell guides, and protective wraps. End cap may be configured to encapsulate at least a portion of the battery cells, the cell retainers, the cell guides, and battery units, as will be discussed further below, end cap may include a protruding boss that clicks into receivers in both ends of the back plate, as well as a similar boss on a second end that clicks into sense board. Side panel may provide another structural element with two opposite and opposing faces and further configured to encapsulate at least a portion of the battery cells, the cell retainers, the cell guides, and battery units.

In embodiments, battery module 600 can include one or more the battery cells. In another embodiment, battery module 600 includes a plurality of individual the battery cells. Battery cells may each include a cell configured to include an electrochemical reaction that produces electrical energy sufficient to power at least a portion of an eVTOL aircraft. Battery cell may include electrochemical cells, galvanic cells, electrolytic cells, fuel cells, flow cells, voltaic cells, or any combination thereof—to name a few. In embodiments, the battery cells may be electrically connected in series, in parallel, or a combination of series and parallel. Series connection, as used herein, includes wiring a first terminal of a first cell to a second terminal of a second cell and further configured to include a single conductive path for electricity to flow while maintaining the same current (measured in Amperes) through any component in the circuit. Battery cells may use the term ‘wired’, but one of ordinary skill in the art would appreciate that this term is synonymous with ‘electrically connected’, and that there are many ways to couple electrical elements like the battery cells together. As an example, the battery cells can be coupled via prefabricated terminals of a first gender that mate with a second terminal with a second gender. Parallel connection, as used herein, includes wiring a first and second terminal of a first battery cell to a first and second terminal of a second battery cell and further configured to include more than one conductive path for electricity to flow while maintaining the same voltage (measured in Volts) across any component in the circuit. Battery cells may be wired in a series-parallel circuit which combines characteristics of the constituent circuit types to this combination circuit. Battery cells may be electrically connected in any arrangement which may confer onto the system the electrical advantages associated with that arrangement such as high-voltage applications, high-current applications, or the like. As used herein, an electrochemical cell is a device capable of generating electrical energy from chemical reactions or using electrical energy to cause chemical reactions. Further, voltaic or galvanic cells are electrochemical cells that generate electric current from chemical reactions, while electrolytic cells generate chemical reactions via electrolysis. As used herein, the term ‘battery’ is used as a collection of cells connected in series or parallel to each other. According to embodiments and as discussed above, any two rows of the battery cells and therefore the cell retainer openings are shifted one half-length so that no two the battery cells are directly next to the next along the length of the battery module 600, this is the staggered arrangement presented in the illustrated embodiment of FIG. 6. Cell retainer may employ this staggered arrangement to allow more cells to be disposed closer together than in square columns and rows like in a grid pattern. The staggered arrangement may also be configured to allow better thermodynamic dissipation, the methods of which may be further disclosed hereinbelow. Cell retainer may include staggered openings that align with the battery cells and further configured to hold the battery cells in fixed positions. Cell retainer may include an injection molded component. Injection molded component may include a component manufactured by injecting a liquid into a mold and letting it solidify, taking the shape of the mold in its hardened form. Cell retainer may include liquid crystal polymer, polypropylene, polycarbonate, acrylonitrile butadiene styrene, polyethylene, nylon, polystyrene, polyether ether ketone, to name a few. Cell retainer may include a second the cell retainer fixed to the second end of the battery cells and configured to hold the battery cells in place from both ends. Second cell retainer may include similar or the exact same characteristics and functions of first the cell retainer. Battery module 600 may also include the cell guide. In embodiments, cell guide can be configured to distribute heat that may be generated by the battery cells. According to embodiments, battery module 600 may also include the back plate. Back plate is configured to provide a base structure for battery module 600 and may encapsulate at least a portion thereof. Backplate can have any shape and includes opposite, opposing sides with a thickness between them. In embodiments, the back plate may include an effectively flat, rectangular prism shaped sheet. For example, the back plate can include one side of a larger rectangular prism which characterizes the shape of battery module 600 as a whole. Back plate also includes openings correlating to each battery cell of the plurality of the battery cells. Back plate may include a lamination of multiple layers. The layers that are laminated together may include FR-6, a glass-reinforced epoxy laminate material, and a thermal barrier of a similar or exact same type as disclosed hereinabove. Back plate may be configured to provide structural support and containment of at least a portion of battery module 600 as well as provide fire and thermal protection. According to embodiments, battery module 600 may also include an end cap configured to encapsulate at least a portion of battery module 600. End cap may provide structural support for battery module 600 and hold the back plate in a fixed relative position compared to the overall battery module 600. End cap may include a protruding boss on a first end that mates up with and snaps into a receiving feature on a first end of the back plate. End cap may include a second protruding boss on a second end that mates up with and snaps into a receiving feature on the sense board. Battery module 600 may also include at least a side panel that may encapsulate two sides of battery module 600. Any side panel may include opposite and opposing faces including a metal or composite material. Side panel(s) may provide structural support for battery module 600 and provide a barrier to separate battery module 600 from exterior components within aircraft or environment.

With continued reference to FIG. 6, any of the disclosed systems, namely battery module 600 or one or more battery packs may incorporate provisions to dissipate heat energy present due to electrical resistance in integral circuit. Battery module 600 includes one or more battery element modules wired in series and/or parallel. The presence of a voltage difference and associated amperage inevitably will increase heat energy present in and around battery module 600 as a whole. The presence of heat energy in a power system is potentially dangerous by introducing energy possibly sufficient to damage mechanical, electrical, and/or other systems present in at least a portion of exemplary aircraft 00. Battery module 600 may include mechanical design elements, one of ordinary skill in the art, may thermodynamically dissipate heat energy away from battery module 600. The mechanical design may include, but is not limited to, slots, fins, heat sinks, perforations, a combination thereof, or another undisclosed element.

With continued reference to FIG. 6, heat dissipation may include material selection beneficial to move heat energy in a suitable manner for operation of battery module 600. Certain materials with specific atomic structures and therefore specific elemental or alloyed properties and characteristics may be selected in construction of battery module 600 to transfer heat energy out of a vulnerable location or selected to withstand certain levels of heat energy output that may potentially damage an otherwise unprotected component. One of ordinary skill in the art, after reading the entirety of this disclosure would understand that material selection may include titanium, steel alloys, nickel, copper, nickel-copper alloys such as Monel, tantalum and tantalum alloys, tungsten and tungsten alloys such as Inconel, a combination thereof, or another undisclosed material or combination thereof.

With continued reference to FIG. 6, heat dissipation may include a combination of mechanical design and material selection. The responsibility of heat dissipation may fall upon the material selection and design as disclosed above in regard to any component disclosed in this paper. Battery module 600 may include similar or identical features and materials ascribed to battery module 600 in order to manage the heat energy produced by these systems and components.

With continued reference to FIG. 6, according to embodiments, the circuitry battery module 600 may include, as discussed above, may be shielded from electromagnetic interference. The battery elements and associated circuitry may be shielded by material such as mylar, aluminum, copper a combination thereof, or another suitable material. Battery module 600 and associated circuitry may include one or more of the aforementioned materials in their inherent construction or additionally added after manufacture for the express purpose of shielding a vulnerable component. Battery module 600 and associated circuitry may alternatively or additionally be shielded by location. Electrochemical interference shielding by location includes a design configured to separate a potentially vulnerable component from energy that may compromise the function of said component. The location of vulnerable component may be a physical uninterrupted distance away from an interfering energy source, or location configured to include a shielding element between energy source and target component. The shielding may include an aforementioned material in this section, a mechanical design configured to dissipate the interfering energy, and/or a combination thereof. The shielding including material, location and additional shielding elements may defend a vulnerable component from one or more types of energy at a single time and instance or include separate shielding for individual potentially interfering energies.

With continued reference to FIG. 6, battery module 600 may be a portion of a battery pack, the battery pack may be a power source that is configured to store electrical energy in the form of a plurality of battery modules, which themselves are included of a plurality of electrochemical cells. These cells may utilize electrochemical cells, galvanic cells, electrolytic cells, fuel cells, flow cells, and/or voltaic cells. In general, an electrochemical cell is a device capable of generating electrical energy from chemical reactions or using electrical energy to cause chemical reactions, this disclosure will focus on the former. Voltaic or galvanic cells are electrochemical cells that generate electric current from chemical reactions, while electrolytic cells generate chemical reactions via electrolysis. In general, the term ‘battery’ is used as a collection of cells connected in series or parallel to each other. A battery cell may, when used in conjunction with other cells, may be electrically connected in series, in parallel or a combination of series and parallel. Series connection includes wiring a first terminal of a first cell to a second terminal of a second cell and further configured to include a single conductive path for electricity to flow while maintaining the same current (measured in Amperes) through any component in the circuit. A battery cell may use the term ‘wired’, but one of ordinary skill in the art would appreciate that this term is synonymous with ‘electrically connected’, and that there are many ways to couple electrical elements like the battery cells together. An example of a connector that do not include wires may be prefabricated terminals of a first gender that mate with a second terminal with a second gender. Battery cells may be wired in parallel. Parallel connection includes wiring a first and second terminal of a first battery cell to a first and second terminal of a second battery cell and further configured to include more than one conductive path for electricity to flow while maintaining the same voltage (measured in Volts) across any component in the circuit. Battery cells may be wired in a series-parallel circuit which combines characteristics of the constituent circuit types to this combination circuit. Battery cells may be electrically connected in a virtually unlimited arrangement which may confer onto the system the electrical advantages associated with that arrangement such as high-voltage applications, high-current applications, or the like. In an exemplary embodiment, the battery pack include 196 battery cells in series and 18 battery cells in parallel. This is, as someone of ordinary skill in the art would appreciate, is only an example and the battery pack may be configured to have a near limitless arrangement of battery cell configurations.

With continued reference to FIG. 6, a battery pack may include a plurality of battery modules 600. Battery modules 600 may be wired together in series and in parallel. Battery pack may include center sheet which may include a thin barrier. The barrier may include a fuse connecting battery modules on either side of center sheet. The fuse may be disposed in or on center sheet and configured to connect to an electric circuit including a first battery module and therefore battery unit and cells. In general, and for the purposes of this disclosure, a fuse is an electrical safety device that operate to provide overcurrent protection of an electrical circuit. As a sacrificial device, its essential component is metal wire or strip that melts when too much current flows through it, thereby interrupting energy flow. Fuse may include a thermal fuse, mechanical fuse, blade fuse, expulsion fuse, spark gap surge arrestor, varistor, or a combination thereof. Battery pack may also include a side wall includes a laminate of a plurality of layers configured to thermally insulate the plurality of battery modules from external components of the battery pack. Side wall layers may include materials which possess characteristics suitable for thermal insulation as described in the entirety of this disclosure like fiberglass, air, iron fibers, polystyrene foam, and thin plastic films, to name a few. Side wall may additionally or alternatively electrically insulate the plurality of battery modules from external components of the battery pack and the layers of which may include polyvinyl chloride (PVC), glass, asbestos, rigid laminate, varnish, resin, paper, Teflon, rubber, and mechanical lamina. Center sheet may be mechanically coupled to side wall in any manner described in the entirety of this disclosure or otherwise undisclosed methods, alone or in combination. Side wall may include a feature for alignment and coupling to center sheet. This feature may include a cutout, slots, holes, bosses, ridges, channels, and/or other undisclosed mechanical features, alone or in combination. Battery pack may also include the end panel including a plurality of electrical connectors and further configured to fix the battery pack in alignment with at least a side wall. End panel may include a plurality of electrical connectors of a first gender configured to electrically and mechanically couple to electrical connectors of a second gender. End panel may be configured to convey electrical energy from the battery cells to at least a portion of an eVTOL aircraft. Electrical energy may be configured to power at least a portion of an eVTOL aircraft or include signals to notify aircraft computers, personnel, users, pilots, and any others of information regarding battery health, emergencies, and/or electrical characteristics. The plurality of electrical connectors may include blind mate connectors, plug and socket connectors, screw terminals, ring and spade connectors, blade connectors, and/or an undisclosed type alone or in combination. The electrical connectors of which the end panel includes may be configured for power and communication purposes. A first end of the end panel may be configured to mechanically couple to a first end of a first side wall by a snap attachment mechanism, similar to end cap and side panel configuration utilized in the battery module. To reiterate, a protrusion disposed in or on the end panel may be captured, at least in part, by a receptacle disposed in or on side wall. A second end of the end panel may be mechanically coupled to a second end of a second side wall in a similar or the same mechanism.

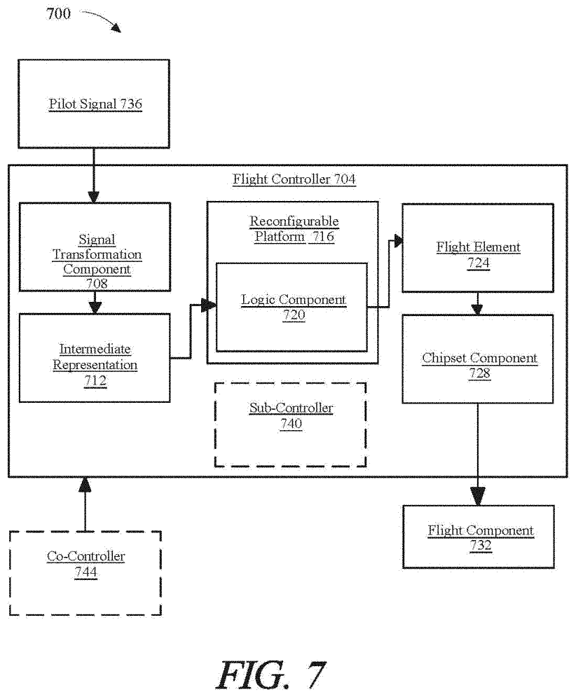

Now referring to FIG. 7, an exemplary embodiment 700 of a flight controller 704 is illustrated. As used in this disclosure a “flight controller” is a computing device of a plurality of computing devices dedicated to data storage, security, distribution of traffic for load balancing, and flight instruction. In some embodiments, flight controller 704 may be in communication with recharging component 108 and/or control pilot 120 as described above in FIG. 1. For example, and without limitation, flight controller 704 may be configured to control ventilation system 112 of port 512 of electric aircraft 500 (shown in FIG. 5). In some embodiments, flight controller 704 may be attached to port of electric vehicle 104. In other embodiments, flight controller 704 may be remote to port and in wireless communication with port of electric vehicle 104. Flight controller 704 may include and/or communicate with any computing device, such as computing device 800 shown in FIG. 8, as described in this disclosure, including without limitation a microcontroller, microprocessor, digital signal processor (DSP) and/or system on a chip (SoC) as described in this disclosure. Further, flight controller 704 may include a single computing device operating independently, or may include two or more computing device operating in concert, in parallel, sequentially or the like; two or more computing devices may be included together in a single computing device or in two or more computing devices. In embodiments, flight controller 704 may be installed in an aircraft, may control the aircraft remotely, and/or may include an element installed in the aircraft and a remote element in communication therewith.

In an embodiment, and still referring to FIG. 7, flight controller 704 may include a signal transformation component 708. As used in this disclosure a “signal transformation component” is a component that transforms and/or converts a first signal to a second signal, wherein a signal may include one or more digital and/or analog signals. For example, and without limitation, signal transformation component 708 may be configured to perform one or more operations such as preprocessing, lexical analysis, parsing, semantic analysis, and the like thereof. In an embodiment, and without limitation, signal transformation component 708 may include one or more analog-to-digital convertors that transform a first signal of an analog signal to a second signal of a digital signal. For example, and without limitation, an analog-to-digital converter may convert an analog input signal to a 10-bit binary digital representation of that signal. In another embodiment, signal transformation component 708 may include transforming one or more low-level languages such as, but not limited to, machine languages and/or assembly languages. For example, and without limitation, signal transformation component 708 may include transforming a binary language signal to an assembly language signal. In an embodiment, and without limitation, signal transformation component 708 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 7, signal transformation component 708 may be configured to optimize an intermediate representation 712. As used in this disclosure an “intermediate representation” is a data structure and/or code that represents the input signal. Signal transformation component 708 may optimize intermediate representation as a function of a data-flow analysis, dependence analysis, alias analysis, pointer analysis, escape analysis, and the like thereof. In an embodiment, and without limitation, signal transformation component 708 may optimize intermediate representation 712 as a function of one or more inline expansions, dead code eliminations, constant propagation, loop transformations, and/or automatic parallelization functions. In another embodiment, signal transformation component 708 may optimize intermediate representation as a function of a machine dependent optimization such as a peephole optimization, wherein a peephole optimization may rewrite short sequences of code into more efficient sequences of code. Signal transformation component 708 may optimize intermediate representation to generate an output language, wherein an “output language,” as used herein, is the native machine language of flight controller 704. For example, and without limitation, native machine language may include one or more binary and/or numerical languages.

In an embodiment, and without limitation, signal transformation component 708 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−1)/4 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 7, flight controller 704 may include a reconfigurable hardware platform 716. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform 716 may be reconfigured to enact any algorithm and/or algorithm selection process received from another computing device and/or created using machine-learning processes.

Still referring to FIG. 7, reconfigurable hardware platform 716 may include a logic component 720. As used in this disclosure a “logic component” is a component that executes instructions on output language. For example, and without limitation, logic component may perform basic arithmetic, logic, controlling, input/output operations, and the like thereof. Logic component 720 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 720 may be organized according to Von Neumann and/or Harvard architecture as a non-limiting example. Logic component 720 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC). In an embodiment, logic component 720 may include one or more integrated circuit microprocessors, which may contain one or more central processing units, central processors, and/or main processors, on a single metal-oxide-semiconductor chip. Logic component 720 may be configured to execute a sequence of stored instructions to be performed on the output language and/or intermediate representation 712. Logic component 720 may be configured to fetch and/or retrieve the instruction from a memory cache, wherein a “memory cache,” as used in this disclosure, is a stored instruction set on flight controller 704. Logic component 720 may be configured to decode the instruction retrieved from the memory cache to opcodes and/or operands. Logic component 720 may be configured to execute the instruction on intermediate representation 712 and/or output language. For example, and without limitation, logic component 720 may be configured to execute an addition operation on intermediate representation 712 and/or output language.

In an embodiment, and without limitation, logic component 720 may be configured to calculate a flight element 724. As used in this disclosure a “flight element” is an element of datum denoting a relative status of aircraft. For example, and without limitation, flight element 724 may denote one or more torques, thrusts, airspeed velocities, forces, altitudes, groundspeed velocities, directions during flight, directions facing, forces, orientations, and the like thereof. For example, and without limitation, flight element 724 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 724 may denote that aircraft is following a flight path accurately and/or sufficiently.

Still referring to FIG. 7, flight controller 704 may include a chipset component 728. As used in this disclosure a “chipset component” is a component that manages data flow. In an embodiment, and without limitation, chipset component 728 may include a northbridge data flow path, wherein the northbridge dataflow path may manage data flow from logic component 720 to a high-speed device and/or component, such as a RAM, graphics controller, and the like thereof. In another embodiment, and without limitation, chipset component 728 may include a southbridge data flow path, wherein the southbridge dataflow path may manage data flow from logic component 720 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 728 may manage data flow between logic component 720, memory cache, and a flight component 732. As used in this disclosure a “flight component” is a portion of an aircraft that can be moved or adjusted to affect one or more flight elements. For example, flight component 732 may include a component used to affect the aircrafts' roll and pitch which may comprise one or more ailerons. As a further example, flight component 732 may include a rudder to control yaw of an aircraft. In an embodiment, chipset component 728 may be configured to communicate with a plurality of flight components as a function of flight element 724. For example, and without limitation, chipset component 728 may transmit to an aircraft rotor to reduce torque of a first lift propulsor and increase the forward thrust produced by a pusher component to perform a flight maneuver.

In an embodiment, and still referring to FIG. 7, flight controller 704 may be configured generate an autonomous function. As used in this disclosure an “autonomous function” is a mode and/or function of flight controller 704 that controls aircraft automatically. For example, and without limitation, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 724. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 704 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 704 will control the ailerons and/or rudders. As used in this disclosure “non-autonomous mode” is a mode that denotes a pilot will control aircraft and/or maneuvers of aircraft in its entirety.

In an embodiment, and still referring to FIG. 7, flight controller 704 may generate autonomous function as a function of an autonomous machine-learning model. As used in this disclosure an “autonomous machine-learning model” is a machine-learning model to produce an autonomous function output given flight element 724 and a pilot signal 736 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 736 may denote that a pilot is controlling and/or maneuvering ailerons, wherein the pilot is not in control of the rudders and/or propulsors. In an embodiment, pilot signal 736 may include an implicit signal and/or an explicit signal. For example, and without limitation, pilot signal 736 may include an explicit signal, wherein the pilot explicitly states there is a lack of control and/or desire for autonomous function. As a further non-limiting example, pilot signal 736 may include an explicit signal directing flight controller 704 to control and/or maintain a portion of aircraft, a portion of the flight plan, the entire aircraft, and/or the entire flight plan. As a further non-limiting example, pilot signal 736 may include an implicit signal, wherein flight controller 704 detects a lack of control such as by a malfunction, torque alteration, flight path deviation, and the like thereof. In an embodiment, and without limitation, pilot signal 736 may include one or more explicit signals to reduce torque, and/or one or more implicit signals that torque may be reduced due to reduction of airspeed velocity. In an embodiment, and without limitation, pilot signal 736 may include one or more local and/or global signals. For example, and without limitation, pilot signal 736 may include a local signal that is transmitted by a pilot and/or crew member. As a further non-limiting example, pilot signal 736 may include a global signal that is transmitted by air traffic control and/or one or more remote users that are in communication with the pilot of aircraft. In an embodiment, pilot signal 736 may be received as a function of a tri-state bus and/or multiplexor that denotes an explicit pilot signal should be transmitted prior to any implicit or global pilot signal.

Still referring to FIG. 7, autonomous machine-learning model may include one or more autonomous machine-learning processes such as supervised, unsupervised, or reinforcement machine-learning processes that flight controller 704 and/or a remote device may or may not use in the generation of autonomous function. As used in this disclosure “remote device” is an external device to flight controller 704. Additionally or alternatively, autonomous machine-learning model may include one or more autonomous machine-learning processes that a field-programmable gate array (FPGA) may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 7, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Flight controller 704 may receive autonomous training data by receiving correlations of flight element, pilot signal, and/or simulation data to an autonomous function that were previously received and/or determined during a previous iteration of generation of autonomous function. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 7, flight controller 704 may receive autonomous machine-learning model from a remote device and/or FPGA that utilizes one or more autonomous machine learning processes, wherein a remote device and an FPGA is described above in detail. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 704. Remote device and/or FPGA may transmit a signal, bit, datum, or parameter to flight controller 704 that at least relates to autonomous function. Additionally or alternatively, the remote device and/or FPGA may provide an updated machine-learning model. For example, and without limitation, an updated machine-learning model may be comprised of a firmware update, a software update, a autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 704 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 7, flight controller 704 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 7, flight controller 704 may include, but is not limited to, for example, a cluster of flight controllers in a first location and a second flight controller or cluster of flight controllers in a second location. Flight controller 704 may include one or more flight controllers dedicated to data storage, security, distribution of traffic for load balancing, and the like. Flight controller 704 may be configured to distribute one or more computing tasks as described below across a plurality of flight controllers, which may operate in parallel, in series, redundantly, or in any other manner used for distribution of tasks or memory between computing devices. For example, and without limitation, flight controller 704 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Massachusetts, USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 7, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 732. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 7, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 704. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 712 and/or output language from logic component 720, wherein output language may include one or more analog-to-digital conversions, low bit rate transmissions, message encryptions, digital signals, binary signals, logic signals, analog signals, and the like thereof described above in detail.

Still referring to FIG. 7, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 7, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 7, flight controller 704 may also be implemented using a “shared nothing” architecture in which data is cached at the worker, in an embodiment, this may enable scalability of aircraft and/or computing device. Flight controller 704 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers. In an embodiment, distributed flight control may include one or more neural networks. For example, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 7, a node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above. In an embodiment, and without limitation, a neural network may receive semantic units as inputs and output vectors representing such semantic units according to weights wᵢ that are derived using machine-learning processes as described in this disclosure.

Still referring to FIG. 7, flight controller may include a sub-controller 740. As used in this disclosure a “sub-controller” is a controller and/or component that is part of a distributed controller as described above; for instance, flight controller 704 may be and/or include a distributed flight controller made up of one or more sub-controllers. For example, and without limitation, sub-controller 740 may include any controllers and/or components thereof that are similar to distributed flight controller and/or flight controller as described above. Sub-controller 740 may include any component of any flight controller as described above. Sub-controller 740 may be implemented in any manner suitable for implementation of a flight controller as described above. As a further non-limiting example, sub-controller 740 may include one or more processors, logic components and/or computing devices capable of receiving, processing, and/or transmitting data across the distributed flight controller as described above. As a further non-limiting example, sub-controller 740 may include a controller that receives a signal from a first flight controller and/or first distributed flight controller component and transmits the signal to a plurality of additional sub-controllers and/or flight components.

Still referring to FIG. 7, flight controller may include a co-controller 744. As used in this disclosure a “co-controller” is a controller and/or component that joins flight controller 704 as components and/or nodes of a distributer flight controller as described above. For example, and without limitation, co-controller 744 may include one or more controllers and/or components that are similar to flight controller 704. As a further non-limiting example, co-controller 744 may include any controller and/or component that joins flight controller 704 to distributer flight controller. As a further non-limiting example, co-controller 744 may include one or more processors, logic components and/or computing devices capable of receiving, processing, and/or transmitting data to and/or from flight controller 704 to distributed flight control system. Co-controller 744 may include any component of any flight controller as described above. Co-controller 744 may be implemented in any manner suitable for implementation of a flight controller as described above.

In an embodiment, and with continued reference to FIG. 7, flight controller 704 may be designed and/or configured to perform any method, method step, or sequence of method steps in any embodiment described in this disclosure, in any order and with any degree of repetition. For instance, flight controller 704 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Referring now to FIG. 8, an exemplary embodiment of a machine-learning module 800 that may perform one or more machine-learning processes as described in this disclosure is illustrated. In one or more embodiments, machine-learning module may be implemented by flight controller 704 (shown in FIG. 7). Machine-learning module may perform determinations, classification, and/or analysis steps, methods, processes, or the like as described in this disclosure using machine learning processes. A “machine learning process,” as used in this disclosure, is a process that automatedly uses training data 804 to generate an algorithm that will be performed by a computing device/module to produce outputs 808 given data provided as inputs 812; this is in contrast to a non-machine learning software program where the commands to be executed are determined in advance by a user and written in a programming language.

Still referring to FIG. 8, “training data,” as used herein, is data containing correlations that a machine-learning process may use to model relationships between two or more categories of data elements. For instance, and without limitation, training data 804 may include a plurality of data entries, each entry representing a set of data elements that were recorded, received, and/or generated together; data elements may be correlated by shared existence in a given data entry, by proximity in a given data entry, or the like. Multiple data entries in training data 804 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 804 according to various correlations; correlations may indicate causative and/or predictive links between categories of data elements, which may be modeled as relationships such as mathematical relationships by machine-learning processes as described in further detail below. Training data 804 may be formatted and/or organized by categories of data elements, for instance by associating data elements with one or more descriptors corresponding to categories of data elements. As a non-limiting example, training data 804 may include data entered in standardized forms by persons or processes, such that entry of a given data element in a given field in a form may be mapped to one or more descriptors of categories. Elements in training data 804 may be linked to descriptors of categories by tags, tokens, or other data elements; for instance, and without limitation, training data 804 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 8, training data 804 may include one or more elements that are not categorized; that is, training data 804 may not be formatted or contain descriptors for some elements of data. Machine-learning algorithms and/or other processes may sort training data 804 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 804 to be made applicable for two or more distinct machine-learning algorithms as described in further detail below. Training data 804 used by machine-learning module 800 may correlate any input data as described in this disclosure to any output data as described in this disclosure.

Further referring to FIG. 8, training data may be filtered, sorted, and/or selected using one or more supervised and/or unsupervised machine-learning processes and/or models as described in further detail below; such models may include without limitation a training data classifier 816. Training data classifier 816 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 800 may generate a classifier using a classification algorithm, defined as a processes whereby a computing device and/or any module and/or component operating thereon derives a classifier from training data 804. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 816 may classify elements of training data to ventilation requirements.

Still referring to FIG. 8, machine-learning module 800 may be configured to perform a lazy-learning process 820 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 804. Heuristic may include selecting some number of highest-ranking associations and/or training data 804 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 8, machine-learning processes as described in this disclosure may be used to generate machine-learning models 824. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 824 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 824 may be generated by creating an artificial neural network, such as a convolutional neural network comprising an input layer of nodes, one or more intermediate layers, and an output layer of nodes. Connections between nodes may be created via the process of “training” the network, in which elements from a training data 804 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 8, machine-learning algorithms may include at least a supervised machine-learning process 828. At least a supervised machine-learning process 828, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include environment datum as described above as inputs, ventilation requirement data as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 804. Persons skilled in the art, upon reviewing the entirety of this disclosure, will be aware of various possible variations of at least a supervised machine-learning process 828 that may be used to determine relation between inputs and outputs. Supervised machine-learning processes may include classification algorithms as defined above.

Further referring to FIG. 8, machine learning processes may include at least an unsupervised machine-learning processes 832. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 8, machine-learning module 800 may be designed and configured to create a machine-learning model 824 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 8, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

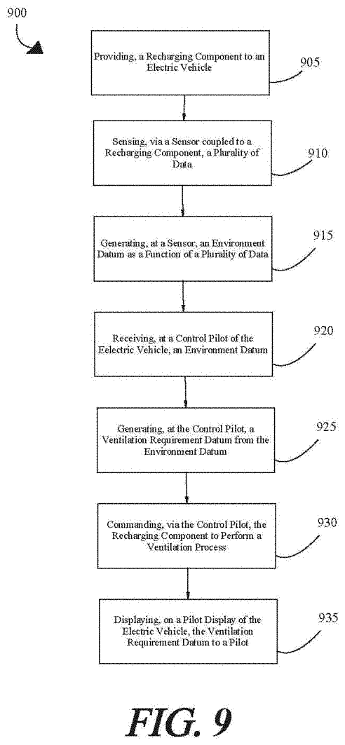

Referring now to FIG. 9, a method 900 for controlling a ventilation process of electric vehicle 104 is presented. At step 905, method 900 includes providing recharging component 108 of electric vehicle 104. A recharging component 108 may include a port of electric vehicle, such as, for example, port 512 of electric aircraft 500 (shown in FIG. 5). Recharging component 108 may be configured to deliver power to an energy source of electric vehicle 104. In some embodiments, providing a recharging component to an electric vehicle may be as described above in FIGS. 1-8.

Still referring to FIG. 9, at step 910, method 900 includes sensing via a sensor coupled to recharging component 108 a plurality of data. A plurality of data may include data such as, but not limited to, air quality, battery temperature, battery quality, battery charge, hydrogen gas levels, voltage, current, resistance, and the like. In some embodiments, sensing a plurality of data from a recharging component may be as described above in FIGS. 1-8.

Still referring to FIG. 9, at step 915, method 900 includes generating at a sensor an environment datum as a function of a plurality of data. An environment datum may include data regarding air quality, temperature, humidity, airborne particle levels, and the like. In some embodiments, generating an environment datum may be as described above in FIGS. 1-8.

Still referring to FIG. 9, at step 920, method 900 includes receiving, at a control pilot of the electric vehicle, an environment datum. Receiving an environment datum may be as described above in FIGS. 1-8.

Still referring to FIG. 9, at step 925, method 900 includes generating at the control pilot a ventilation requirement datum from the environment datum. A ventilation requirement datum may be generated as described above in FIGS. 1-8.

Still referring to FIG. 9, at step 930, method 900 includes commanding via the control pilot the recharging component to perform a ventilation process. A ventilation process may be as described above in FIG. 1.

Still referring to FIG. 9, at step 935, method 900 includes displaying, on a pilot display of the electric vehicle, the ventilation requirement datum to a pilot. Displaying on a pilot display a ventilation requirement may be as described above in FIGS. 1-8.

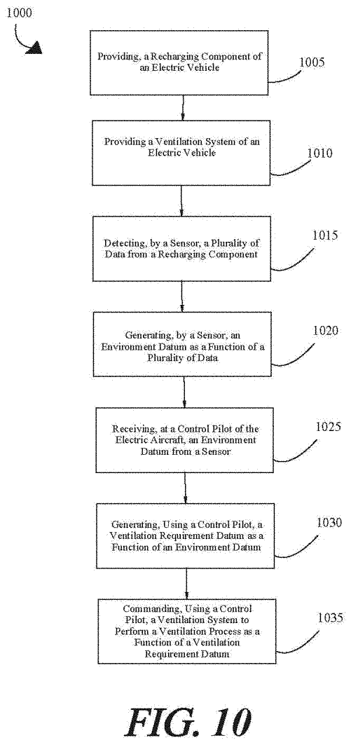

Referring now to FIG. 10, a flowchart of method 1000 of providing ventilation during a recharging of an electric vehicle is disclosed. Method 1000 includes a step 1005 of providing a recharging component of an electric vehicle, wherein the recharging component is configured to supply power to an energy source of an electric vehicle. In some embodiments, the recharging component may include a port of the electric aircraft, wherein the port is communicatively connected to the energy source. In some embodiments, the recharging component may further include an alarm system. These may be implemented as disclosed with respect to FIGS. 1-9.

With continued reference to FIG. 10, method 1000 includes a step 1010 of providing a ventilation system of an electric. In some embodiments, the ventilation system may include an exhaust device. These may be implemented as disclosed with respect to FIGS. 1-9.

With continued reference to FIG. 10, method 1000 includes a step 1015 of detecting, by a sensor, a plurality of data from a recharging component. These may be implemented as disclosed with respect to FIGS. 1-9.

With continued reference to FIG. 10, method 1000 includes a step 1020 of generating, by a sensor, an environment datum as a function of a plurality of data. These may be implemented as disclosed with respect to FIGS. 1-9.

With continued reference to FIG. 10, method 1000 includes a step 1025 of receiving, at a control pilot of an electric aircraft, the environment datum from a sensor. These may be implemented as disclosed with respect to FIGS. 1-9.

With continued reference to FIG. 10, method 1000 includes a step 1030 of generating, using a control pilot, a ventilation requirement datum as a function of an environment datum. These may be implemented as disclosed with respect to FIGS. 1-9.

With continued reference to FIG. 10, method 1000 includes a step 1035 of commanding, using a control pilot, a ventilation system to perform a ventilation process as a function of a ventilation requirement datum. In some embodiments, method 1000 may further include directing, using the ventilation system, a flow of air to a cabin of the electric vehicle. In some embodiments, method 1000 may further include adjusting, using a flow controlling device of the ventilation system, an amount of the flow of the particles through the ventilation system. In some embodiments, method 1000 may further include adjusting, using the flow controlling device, a power to the flow controlling device. In some embodiments, method 1000 may further include directing, using the ventilation system, the flow of the particles away from a cabin of the electric vehicle. In some embodiments, method 1000 may further include displaying, using a pilot display coupled to the electric vehicle, the ventilation requirement datum to a pilot. In some embodiments, method 1000 may further include improving, using the ventilation process, an environment quality of the energy source. These may be implemented as disclosed with respect to FIGS. 1-9.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

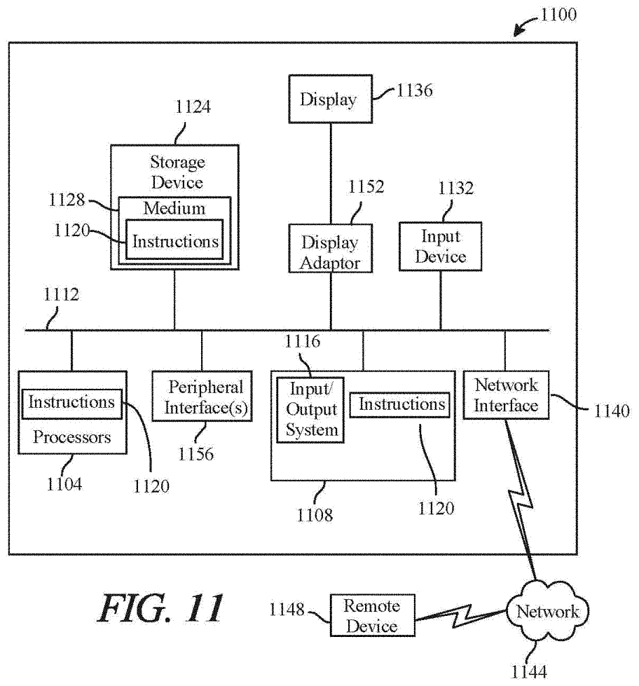

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for recharging an electric vehicle, the system comprising:
a recharging component, wherein the recharging component is configured to supply power to an energy source of an electric vehicle;
a sensor configured to:
detect a plurality of data regarding the electric vehicle; and
generate an environment datum as a function of the plurality of data;
a ventilation system, wherein the ventilation system is communicatively connected to the recharging component; and
a control pilot, wherein the control pilot is in electronic communication with the sensor, wherein the control pilot is configured to:
receive the environment datum from the sensor;
generate a ventilation requirement datum as a function of the environment datum; and
command the ventilation system to perform a ventilation process as a function of the ventilation requirement datum.

2. The system of claim 1, wherein the ventilation system comprises an exhaust device.

3. The system of claim 1, wherein the ventilation system is configured to direct a flow of air to a cabin of the electric vehicle.

4. The system of claim 1, wherein the ventilation system comprises a flow controlling device, wherein the flow controlling device is configured to adjust an amount of the flow of the particles through the ventilation system.

5. The system of claim 4, wherein the flow controlling device is further configured to adjust a power of the flow controlling device.

6. The system of claim 1, wherein the ventilation system is further configured to direct the flow of the particles away from a cabin of the electric vehicle.

7. The system of claim 1, further comprising a pilot display coupled to the electric vehicle, wherein the pilot display is configured to display the ventilation requirement datum to a pilot.

8. The system of claim 1, wherein the recharging component comprises a port of the electric aircraft, wherein the port is communicatively connected to the energy source.

9. The system of claim 1, wherein the ventilation process is configured to improve an environment quality of the energy source.

10. The system of claim 1, wherein the recharging component further comprises an alarm system.

11. A method of recharging an electric vehicle, the method comprising:
providing a recharging component of an electric vehicle, wherein the recharging component is configured to supply power to an energy source of an electric vehicle;
providing a ventilation system of the electric vehicle, wherein the ventilation system is communicatively connected to the recharging component;
detecting, by a sensor, a plurality of data from the recharging component;
generating, by the sensor, an environment datum as a function of the plurality of data;
receiving, at a control pilot of the electric aircraft, the environment datum from the sensor;
generating, using the control pilot, a ventilation requirement datum as a function of the environment datum; and
commanding, using the control pilot, the ventilation system to perform a ventilation process as a function of the ventilation requirement datum.

12. The method of claim 11, wherein the ventilation system comprises an exhaust device.

13. The method of claim 11, further comprising:
directing, using the ventilation system, a flow of air to a cabin of the electric vehicle.

14. The method of claim 11, further comprising:
adjusting, using a flow controlling device of the ventilation system, an amount of the flow of the particles through the ventilation system.

15. The method of claim 14, further comprising:
adjusting, using the flow controlling device, a power of the flow controlling device.

16. The method of claim 11, further comprising:
directing, using the ventilation system, the flow of the particles away from a cabin of the electric vehicle.

17. The method of claim 11, further comprising:
displaying, using a pilot display coupled to the electric vehicle, the ventilation requirement datum to a pilot.

18. The method of claim 11, wherein the recharging component comprises a port of the electric aircraft, wherein the port is communicatively connected to the energy source.

19. The method of claim 11, further comprising:
improving, using the ventilation process, an environment quality of the energy source.

20. The method of claim 11, wherein the recharging component further comprises an alarm system.
